(19) United States
(12) Patent Application Publication
(10) Pub. No.: US 2026/0351278 A1
(43) Pub. Date: Nov. 5, 2026

(54) SYSTEM FOR VOICE MESSAGE PROCESSING BASED ON NETWORK TRANSITION PREDICTION

(71) Applicant: LG ELECTRONICS INC., Seoul (KR)

(72) Inventors: Sehyeok IM, Seoul (KR); Jaemin SON, Seoul (KR); Sujin KIM, Seoul (KR); Taegun PARK, Seoul (KR)

(73) Assignee: LG ELECTRONICS INC., Seoul (KR)

(21) Appl. No.: 19/661,308

(22) Filed: Apr. 28, 2026

(30) Foreign Application Priority Data
Apr. 30, 2025 (KR) 10-2025-0057548
Jan. 22, 2026 (WO) PCT/KR2026/095007

(51) Int. Cl. G10L 25/51; G10L 13/02; G10L 15/26; H04W 36/14; H04W 36/30; H04W 84/06

(52) U.S. Cl. CPC G10L 25/51; G10L 13/02; G10L 15/26; H04W 36/14; H04W 36/30; H04W 84/06

(57) ABSTRACT

A user terminal includes: a microphone configured to receive a voice message; a communication module including an antenna and configured to enable terrestrial network (TN) communication and non-terrestrial network (NTN) communication using a satellite; and a processor operably connected to the communication module and configured to transmit the voice message using at least one communication method from among the TN communication and the NTN communication, wherein the processor is configured to: predict a communication zone corresponding to an expected location on a driving path of the user terminal, based on a TN signal or an NTN signal each collected through the antenna; determine a transmission protocol or a data format of the voice message based on a result of the prediction; and transmit, to a server, the voice message constructed according to the determination.

### CROSS-REFERENCE TO RELATED APPLICATION

Pursuant to 35 U.S.C. § 119(a), this application claims the benefit of the earlier filing date and the right of priority to Korean Patent Application No. 10-2025-0057548, filed on Apr. 30, 2025, and International Patent Application No. PCT/KR2026/095007, filed on Jan. 22, 2026, the contents of which are incorporated by reference herein in their entirety.

### BACKGROUND

### 1. Field

This disclosure relates to a network transition prediction-based voice message processing system. More specifically, this disclosure relates to a message processing system and a method for providing a seamless voice messaging service by predicting a possibility of a network transition between a terrestrial network (TN) and a non-terrestrial network (NTN) according to a driving path of a vehicle and sharing network state information by interoperating with a server.

### 2. Description of the Related Art

With recent advancement of vehicle technologies, various new technologies such as autonomous driving, a software defined vehicle (SDV), vehicle-to-everything (V2X), and connected car technologies utilizing satellite communications are being applied. Vehicles are evolving beyond simple transportation means into complex communication terminals capable of transmitting and receiving large volumes of data in real time. Accordingly, there is an increasing number of attempts to build an environment in which communication may be performed anytime and anywhere by combining not only a terrestrial network (TN) based on a cellular base station but also a non-terrestrial network (NTN) utilizing a low Earth orbit satellite and the like.

In particular, technologies for dynamically transitioning between the TN and the NTN to ensure communication continuity are becoming increasingly important to maintain emergency rescue requests or voice messaging services even in dead zones, remote areas, or at sea that terrestrial network signals may not reach during driving of a vehicle. From a perspective of vehicle manufacturers and service providers, a main objective is to provide seamless high-quality voice services to users in heterogeneous network environments in which both the TN and the NTN are present.

However, voice message services in heterogeneous TN and NTN network communication environments have several technical limitations and problems as described below.

First, there is a problem of service interruption caused by abrupt environmental changes between heterogeneous networks. Systems in the related art adopt a reactive approach in which a satellite network connection is attempted only after a terrestrial network signal is completely lost. As a result, a significant level of handover delay occurs at a time point of network transition from the TN to the NTN, and during a voice message transmitting and receiving process in which real-time performance is important, packet loss or communication interruption may occur, thereby severely worsening a service experience of a user.

Second, there is a problem of voice quality degradation due to a low bandwidth and high latency characteristics of the NTN. Compared to the TN, the NTN utilizing satellites has technical limitations such as a very narrow available bandwidth and high signal delay. Technologies in the related art use only a voice codec with a fixed bitrate regardless of network conditions. Accordingly, in an NTN environment in which a bandwidth is limited, a voice data transmission rate cannot keep up with a network speed, resulting in a message transmission failure or a significant degradation in received voice quality. Thus, there is a limitation in that communication cannot be performed.

Third, there is a lack of intelligent predictive control technology for driving paths and network conditions. Vehicles move at high speeds and a communication environment changes rapidly due to surrounding geographical features. However, systems in the related art are unable to proactively predict changes in communication zones in a current location or along a future driving path of the vehicle. As a result, even when a network transition is imminent, intelligent measures such as optimizing a data format or sharing state information with a server in advance may not be taken. This ultimately causes waste of network resources and service discontinuity.

### SUMMARY

Therefore, the disclosure is directed to solving the aforementioned problems and other drawbacks, and an objective of the disclosure is to prevent a handover delay and a packet loss which occur during network transition and provide a seamless voice messaging service by proactively predicting a possibility of network transition between a terrestrial network (TN) and a non-terrestrial network (NTN) according to a driving path of a vehicle and sharing network state information by interoperating with a server.

Another objective of the disclosure is to dynamically switch a voice data format into real voice or text-based virtual voice depending on a network state and simultaneously secure both a communication success rate and voice quality through a hybrid transmission method of transmitting text data together with low bit-rate voice data to overcome low-bandwidth and high-latency characteristics of the NTN.

Another objective of this disclosure is to maximize network resource efficiency and ensure service continuity by pre-optimizing a data format at a time point when a communication zone change is imminent through intelligent predictive control technology and dynamically controlling a response message transmission path by enabling a server to recognize a state change of a terminal in advance.

Another objective of the disclosure is to provide an enhanced user experience (UX) by maintaining individual voice features even in low-bandwidth environments by performing voice synthesis and restoration processing for reproducing a unique voice color of a sender using a voice identifier transmitted when virtual voice is received.

In order to achieve these and other advantages and in accordance with the purpose of the specification, as embodied and broadly described herein, there is provided a user terminal according to the disclosure including: a microphone configured to receive a voice message; a communication module including an antenna and configured to enable terrestrial network (TN) communication and non-terrestrial network (NTN) communication using a satellite; and a processor operably connected to the communication module and configured to transmit the voice message using at least one communication method from among the TN communication and the NTN communication, wherein the processor is configured to: predict a communication zone corresponding to an expected location on a driving path of the user terminal, based on a TN signal or an NTN signal each collected through the antenna; determine a transmission protocol or a data format of the voice message based on a result of the prediction; and transmit, to a server, the voice message constructed according to the determination.

According to an embodiment, the communication zone may be classified into a TN zone, an NTN zone, and a TN/NTN zone, and the TN/NTN zone may be a network transition preparation area between the TN communication and the NTN communication.

According to an embodiment, the processor may variably adjust a coverage boundary of the TN/NTN zone in proportion to a driving speed of a vehicle in which a user of the user terminal is riding.

According to an embodiment, when a current location of the user terminal is in the NTN zone, the processor may control the voice message to be converted into text data to cause the text data to be transmitted to the server via the satellite.

According to an embodiment, when a current location of the user terminal is in the TN zone, the processor may control the voice message to be transmitted to the server via a terrestrial network base station.

According to an embodiment, the processor may be configured to: predict a possibility of a change in the communication zone within a preset threshold time based on at least one from among an NTN map, a vehicle location, and the driving path, each received from the server; and determine whether a network transition between the TN communication and the NTN communication is to be performed within the preset threshold time, based on a result of the prediction.

According to an embodiment, when it is determined that the network transition between the TN communication and the NTN communication is to be performed within the preset threshold time, the processor may add, to the voice message, a network transition indicator notifying that the network transition is scheduled and transmit the voice message to which the network transition indicator is added.

According to an embodiment, when a current location of the user terminal is in the TN/NTN zone, the processor may transmit the voice message by selecting at least one communication method among the TN communication and the NTN communication based on network quality of service (QoS) of the TN communication and the NTN communication.

According to an embodiment, the processor may display, on a display of the user terminal, a first network indicator and a second network indicator indicating connection states and signal strengths of the TN communication and the NTN communication, respectively, and the first network indicator may correspond to the selected communication method and be visually distinguished from the second network indicator.

According to an embodiment, the processor may be configured to: analyze the voice message to determine whether an emergency context has occurred or an emergency urgency level; and according to a result of the determination, transmit the voice message by selecting at least one communication method among the TN communication and the NTN communication.

According to an embodiment, the processor may be configured to: transmit a text message corresponding to the voice message via the NTN communication when the emergency urgency level is equal to or greater than a preset threshold value; and control the transmission of the voice message via the NTN communication to be delayed when the emergency urgency level is less than the preset threshold value.

According to an embodiment, the processor may be configured to: in the converting of the voice message into the text data, obtain a voice identifier for identifying personal voice features of a user from the voice message; and add the voice identifier to the text data, and transmit the text data to which the voice identifier is added.

According to an embodiment, when the text data is received, the processor may convert the text data into a voice message and plays back the voice message obtained by the converting, based on the voice identifier added to the text data, and the personal voice features corresponding to the voice identifier may be reflected in the voice message obtained by the converting.

According to an embodiment, the processor may perform at least one of summarization and compression on the text data, and transmit the text data on which the at least one of summarization and compression is performed.

According to an embodiment, the processor may be configured to: generate voice data by encoding the voice message at a low bit rate when a current location of the user terminal is in the NTN zone; and transmit the text data together with the voice data generated at the low bit rate.

According to an embodiment, when the text data and the voice data at the low bit rate are received, the processor may convert the text data into a voice message and plays back the voice message obtained by the converting, and blend the voice data generated at the low bit rate as background sound and output the background sound together.

According to an embodiment, the NTN map may include information about an NTN communication available area on the driving path of the user terminal.

According to an embodiment, the NTN map may be generated in units of zones by clustering communication state data collected from a plurality of vehicle terminals including the user terminal, and each of the generated zones may be managed separately by each of a plurality of satellite operators.

A method of controlling a user terminal according to the disclosure may include: receiving a voice message through a microphone; predicting a communication zone corresponding to an expected location on a driving path of the user terminal, based on a terrestrial network (TN) signal or a non-terrestrial network (NTN) signal each collected through the antenna; determining a transmission protocol or a data format of the voice message based on a result of the prediction; and transmitting, to a server, the voice message constructed according to the determination using at least one communication method among TN communication and NTN communication according to the determination.

A message processing system configured to dynamically transition a method of transmitting a voice message between terrestrial network (TN) communication and non-terrestrial network (NTN) communication may include: a user terminal; and a server configured to transmit and receive the voice message to/from the user terminal, wherein the user terminal includes: a microphone configured to receive the voice message; a communication module including an antenna and configured to enable the TN communication and the NTN communication using a satellite; and a processor operably connected to the communication module and configured to transmit the voice message using at least one communication method from among the TN communication and the NTN communication, wherein the processor is configured to: predict a communication zone corresponding to an expected location on a driving path of the user terminal, based on a TN signal or an NTN signal each collected through the antenna; determine a transmission protocol or a data format of the voice message based on a result of the prediction; and transmit, to the server, the voice message constructed according to the determination.

According to the disclosure, communication interruption and a handover delay which may occur during network transition may be effectively prevented by proactively predicting network transition between a TN and an NTN based on a driving path of a vehicle and sharing state information with a server. Accordingly, a user may receive a seamless latency-free voice messaging service in spite of rapid changes in a communication environment, and continuity and reliability of the service may be improved.

According to the disclosure, even in a low-bandwidth and high-latency environment of the NTN, communication resource constraints may be efficiently overcome by dynamically selecting real voice and a virtual voice format in correspondence with a network state and performing a hybrid transmission method of combining text and low-bitrate voice with each other. This allows to optimize a data packet size to increase a communication success rate, while enabling rapid and accurate transmission of main information of a message even under network congestion contexts.

According to the disclosure, waste of limited satellite communication resources may be minimized by optimizing a data format prior to a change in a communication zone through intelligent predictive control technology and dynamically controlling a transmission path by enabling a server to recognize a location change of a terminal. In addition, through close interoperation between the server and the terminal, an optimal path for receiving a response message may be secured in any network environment, thereby maximizing operational efficiency of the entire system.

According to the disclosure, individual voice features may be preserved even in text-based communication under low-bandwidth environments by performing speech synthesis and restoration for reproducing a unique voice color of a speaker using a voice identifier transmitted when virtual voice is received. Accordingly, a high-quality voice service for preserving a sense of realism and identity of a sender beyond mere information delivery may be provided, and user experience (UX) and service satisfaction may be enhanced.

### BRIEF DESCRIPTION OF THE DRAWINGS

The above and other aspects, features and other advantages of the disclosure will be more clearly understood from the following detailed description taken in conjunction with the accompanying drawings, in which:

FIG. 1 is a conceptual diagram illustrating an embodiment of a non-terrestrial network (NTN) system according to the disclosure;

FIG. 2 is a block diagram of a user terminal according to the disclosure;

FIG. 3 is a block diagram of an artificial intelligence (AI) assistant server according to the disclosure;

FIG. 4 is a flowchart of operation between respective modules of the user terminal, a server, and an emergency response center, each being configured to perform transmission and reception of voice messages through network transition prediction according to the disclosure;

FIG. 5 illustrates an embodiment in which a terrestrial network (TN) zone, an NTN zone, and a TN/NTN zone according to the disclosure are generated;

FIGS. 6A and 6B illustrate examples in which radii of the TN/NTN zone and a vehicle area are dynamically adjusted, respectively, in correspondence with changes in a driving speed of the vehicle according to the disclosure;

FIG. 7 illustrates an internal block diagram of the user terminal configured to perform voice message transmission and reception through the network transition prediction according to the disclosure, and an interface of the user terminal with a server;

FIG. 8 illustrates a sequence for transmitting and playing back a voice message according to a connected network environment according to the disclosure;

FIG. 9 illustrates a sequence for transmitting and playing back a voice message based on a voice identifier according to the disclosure;

FIG. 10 illustrates a sequence for transmitting and playing back a voice message according to a message type according to the disclosure;

FIG. 11 illustrates a sequence for dynamically switching a transmission protocol or a data format of a voice message based on a possibility of network transition according to the disclosure;

FIGS. 12A to 12C illustrate examples of a method of generating an NTN map based on vehicle status information and orbit information with respect to each satellite operator according to the disclosure;

FIG. 13 is a conceptual diagram of a voice message transmission and reception scenario for determining a transmission protocol and a data format based on a result of predicting of a network transition area (a TN/NTN switching area) according to the disclosure;

FIG. 14 illustrates an embodiment in which voice messages are transmitted and received in an NTN environment according to the disclosure; and

FIGS. 15A and 15B illustrate embodiments in which voice messages are transmitted and received when a communication zone is changed from a TN to an NTN according to the disclosure, respectively.

### DETAILED DESCRIPTION OF THE EMBODIMENTS

It should be noted that the technical terms used herein are for the purpose of describing specific embodiments only and are not intended to limit the disclosure. In addition, a singular representation used herein may include a plural representation unless it represents a definitely different meaning from the context. Suffixes "module" and "unit" used for components used in the following description are merely intended for easy description of the specification, and each suffix itself is not intended to give any special meaning or function.

In the disclosure, the terms "comprising" or “including” should not be construed to necessarily include all of the elements or steps disclosed herein, and should be construed not to include some of the elements or steps thereof, or should be construed to further include additional elements or steps.

In addition, in describing the disclosure, the detailed description will be omitted when a specific description for publicly known technologies to which the disclosure pertains is judged to obscure the gist of the disclosure.

The accompanying drawings are used to help easily understand the technical idea of the disclosure and it should be understood that the idea of the disclosure is not limited by the accompanying drawings. The idea of the disclosure should be construed to extend to any alterations, equivalents, and substitutes besides the accompanying drawings It should be understood that not only the embodiments described below but also combinations of embodiments may be included within the technical idea and scope of the disclosure as modifications, equivalents, or substitutes.

Hereinafter, embodiments disclosed in the specification will be described in detail with reference to the accompanying drawings.

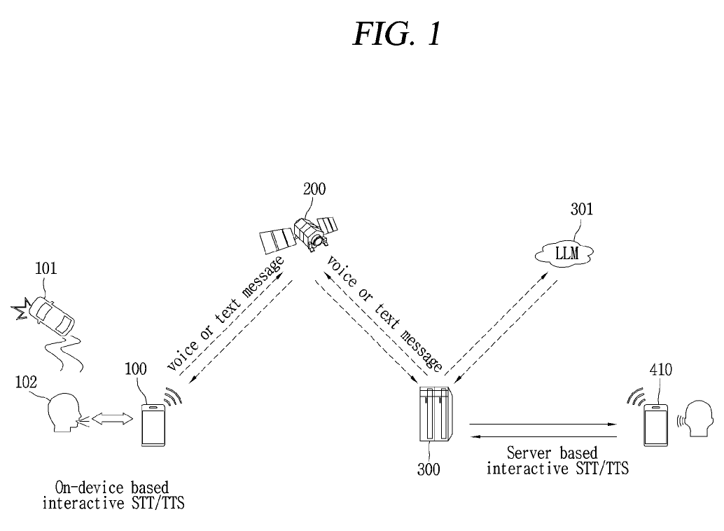

FIG. 1 is a conceptual diagram illustrating an embodiment of a non-terrestrial network (NTN) system according to the disclosure.

Referring to FIG. 1, the NTN system according to the disclosure may include at least a user terminal 100, a satellite 200, and a server 300 for artificial intelligence (AI) assistance. In addition, the NTN system may further include an external service provider configured to interoperate with the AI assistant server 300, i.e., an emergency response center 410 and a telephone reservation center (not shown).

The user terminal 100 according to the disclosure may be configured to transmit a voice message from a vehicle 101.

In the specification, the user terminal 100 is not limited to a portable device, such as a smartphone. It should be noted that, in an embodiment, the vehicle 101 may perform a role of the user terminal 100 or components of the user terminal 100 may be implemented integrally in the vehicle 101. Therefore, in the specification, the user terminal 100 and the vehicle 101 may be used interchangeably or interpreted as a same entity depending on an implementation method, and the scope of the disclosure is not limited by a particular form.

Referring to FIG. 1, the user terminal 100 may communicate with the server 300 by interoperating with an NTN through the satellite 200.

In an embodiment, when the user terminal 100 is located in a region in which a TN service is currently unavailable or quality is below a preset criterion, a transmission path may be switched to NTN communication via the satellite 200. Thus, even when a heterogeneous network transition occurs between a TN and the NTN, the user terminal 100 may transmit and receive voice or text data to/from the server 300 without interruption.

In another embodiment, the user terminal 100 may control a data transmission path with the server 300 to dynamically transition the TN or the NTN based on communication zone information on a driving path and driving path prediction.

In detail, the user terminal 100 according to the disclosure may classify communication available regions on the driving path into a TN zone, an NTN zone, and a TN/NTN zone to manage the communication available regions. Here, the TN/NTN zone is an overlapping region in which both TN communication and the NTN communication are available, and may refer to an available region in which a network transition process is prepared in advance or an optimal path is selected based on quality of service (QoS).

In addition, the user terminal 100 may predict, in real time, a possibility of network transition according to movement between zones in consideration of a driving state (e.g., a speed, a direction, etc.) of the vehicle 101, and based on this, determine a transmission method and a data format of a voice message. A detailed embodiments thereof will be explained in detail with reference to the drawings to be described below.

The user terminal 100 according to the disclosure may receive a user voice message, vehicle sensor data, and a user interface (UI) input through the user terminal 100. In an embodiment, the user terminal 100 may receive voice data from a user 102 located inside or near the vehicle 101 and may convert the received voice data into a data format optimized for a network environment currently available. In detail, the user terminal 100 may dynamically control a data transmission method based on a type of currently connected radio access technology (RAT).

In an embodiment, when the currently connected RAT is an NTN, the user terminal 100 may convert a collected voice message into text data and transmit the text data to the server 300 via the satellite 200. At this time, the user terminal 100 may perform on-device interactive speech-to-text (STT) and text-to-speech (TTS) functions. That is, the user terminal 100 may independently perform a process of recognizing voice of a user as text data through an internal artificial intelligence model and transmitting the recognized voice, or converting a text response received from the server 300 into synthetic voice and outputting the synthetic voice. This minimizes transmission traffic in an NTN environment in which wireless resources are limited, and enables stable message transmission even in an emergency context in which transmission of large-volume voice data is difficult.

In another embodiment, when the currently connected RAT is a TN, the user terminal 100 may transmit a collected voice message to the server 300 in a form of voice packet data. In this case, the user terminal 100 may compress a received voice signal using a preset voice codec or generate a received voice signal as a voice frame in appropriate packet units suitable for real-time transmission and transmit the voice frame.

Meanwhile, the user terminal 100 may obtain sensor data regarding a vehicle status and a driver state from one or more sensors (e.g., driving sensors, biometric sensors, attitude recognition sensors, cameras, or collision detection sensors) included in the vehicle 101. Additionally, the user terminal 100 may determine a current context type by pre-processing at least one of the voice data, sensor data, and a UI input through an on-device AI model.

The context type may be classified, for example, into 'Type 0 (emergency call)' to 'Type 4 (general information search)' according to urgency. In detail, 'Type 0' may indicate an 'emergency call’ context, i.e., a context that needs immediate rescue (e.g., direct 911 call). 'Type 1' and 'Type 2' may indicate 'emergency response guide' contexts in which there is no threat to life but an emergency first aid manual guide is needed for medical advice or simple measures. In addition, 'Type 3' or 'Type 4' may refer to a 'telephone reservation' or 'information search' context for general context-based information conversation or guidance services.

In particular, the user terminal 100 may determine a context type by combining a result of analysis of features of voice of the user (tone, intensity, etc.) with weights associated with a driving environment (a highway, a communication dead zone, etc.) of the vehicle 101. At this time, the context type may be determined based on a trigger type indicating an input type triggered by any one of a user voice input, a sensor input, and a UI manipulation input.

For example, when a vehicle collision sensor is detected or a tone and intensity of the user's voice are analyzed as being be equal to or greater than a preset threshold value, the context type may be determined as 'Type 0 (emergency call)' having a highest priority. As another example, as a result of analyzing location information included in input information, it may be determined that the vehicle is located in a region with a high risk of secondary accidents such as a highway or a tunnel or a communication dead zone. In this case, the user terminal 100 may upgrade an emergency urgency level by assigning a preset weight, and determine the context type accordingly.

Information of the determined context type may be added to a header or a metadata area of the text data or the voice packet data, and then, transmitted to the server 300. The user terminal 100 or server 300 may determine a priority of network transition and data processing through the transmitted context type information.

Meanwhile, a classification scheme of the context type in the specification is not limited to Type 0 to Type 4 described above. In an embodiment, new context types may be further defined as types of collected multimodal data are expanded or as service scenarios provided through the system according to the disclosure diversify. In addition, it should be noted that a plurality of preset context types may be operated by being integrated into a single category depending on a system operating method. Therefore, Types 0 to 4 presented as an example in the specification are merely functional classifications to help to understand the disclosure, and the scope of the disclosure is not limited by specific names or numbers.

The AI assistant server 300 may transmit and receive text data or voice packet data to/from the user terminal 100 via the satellite 200 or a terrestrial network base station (not shown). In addition, the server 300 may provide a service corresponding to a context by interoperating with the emergency response center 410 and the telephone reservation center (not shown).

In an embodiment, the AI assistant server 300 may operate by interoperating with a gateway infrastructure operated by a satellite communication operator. For example, the AI assistant server 300 may operate in a location adjacent to a gateway device connecting the satellite 200 and the TN, or may be configured as a server cluster inside the gateway device. In still another embodiment, the AI assistant server 300 may be arranged in an external cloud environment constructed based on a public network or a private network and configured to receive and process data transmitted through a satellite gateway.

In another embodiment, the server 300 may directly interoperate with the core network of the TN or be connected to a terrestrial network base station via an Internet network. When the user terminal 100 is located in the TN zone, the server 300 may receive voice packet data in real time through a high-speed data path of the TN without going through the satellite gateway.

Additionally, the AI assistant server 300 may be configured to operate by interworking with a large language model (LLM) 301. Here, the LLM 301 may refer to an artificial intelligence model configured to perform natural language understanding and response generation with respect to a user input through a pre-trained large-scale corpus. In addition, the LLM 301 may be provided in a form of a cloud-based AI service.

The AI assistant server 300 according to the disclosure may be configured to perform an operation corresponding to a context type included in the text data or the voice packet data received from the user terminal 100. In an embodiment, when receiving text data or voice packet data with a context type of Type 0, the AI assistant server 300 may be configured to activate a server-based conversational AI to interoperate with the emergency response center 410 to thereby transmit an emergency rescue request and perform a voice call instead of the user.

In another embodiment, when text data or voice packet data with a context type of Type 1 or Type 2 is received, the AI assistant server 300 may generate a prompt suitable for a context and provide the prompt to the LLM 301. In response to this, the server 300 may receive an LLM response including a result of analyzing a context from the LLM 301 and reanalyze the context. At this time, in case when it is determined that the context is serious, the server 300 may automatically switch to an emergency call mode and perform a fail-safe logic for connection to the emergency response center 410. Otherwise, the server 300 may reconstruct the LLM response and transmit the reconstructed LLM response to the user terminal 100.

In still another embodiment, when text data or voice packet data with a context type of Type 3 or Type 4, the AI assistant server 300 may provide a corresponding service by interoperating with a telephone reservation center (not shown) or an external search engine. To do so, the AI assistant server 300 may perform automatic reservation or information search, and then, generate a response message including a result of the performing.

Then, the user terminal 100 may receive the response message from the server 300 via the satellite 200 or the terrestrial network base station and, in some cases, perform bidirectional communication. In an embodiment, when a response message in a form of text data is received from the server 300, the user terminal 100 may translate the text data into a target language or convert the text data into voice through an on-device TTS function and output the target language or the voice to the user 102. In another embodiment, when a response message in a form of voice packet data is received from the server 300, the user terminal 100 may restore the received voice packet data through a predetermined codec and play back the restored voice packet data in a form of a voice message.

Referring back to FIG. 1, in an NTN-based emergency response system according to the disclosure, the user 102 acts as a speaker configured to transmit a voice message, and the emergency response center 410 may function as a listener that receives and responds to the voice message. Additionally, the AI assistant server 300 may analyze and relay data between the user terminal 100 and the emergency response center 410. In an embodiment, the user terminal 100 and the server 300 may be configured to selectively perform on-device based interactive speech-to-text (STT)/text-to-speech (TTS) or server-based interactive STT/TTS depending on a communication environment and a context type.

In this regard, the AI assistant server 300 may analyze a received voice message and transmit an emergency response guide for each context to the user terminal 100 or, as needed, directly perform a voice-based conversation (a call conversation) with the emergency response center 410. In particular, when performing a call with the emergency response center 410, the server 300 may perform TTS in which acoustic features of the user are reflected, based on a personal voice identifier generated in a process of performing STT or stored in advance. In addition, the emergency response center 410 configured to function as a listener may receive text data from the server 300 and play back a voice signal to which the personal voice identifier is applied.

Meanwhile, when receiving an emergency response guide from the server 300, the user terminal 100 may check a voice identifier pre-stored inside the user terminal 100 or included in the received text data. Then, the user terminal 100 may perform on-device TTS based on the checked voice identifier to output a voice message in which acoustic features of the user 102 are reflected.

Meanwhile, the classification of the context types, the classification being processed by the AI assistant server 300 in the specification, and service modes corresponding thereto are not limited to Type 0 to Type 4 described above. As types of multimodal data collected from the user terminal 100 are expanded or service scenarios provided through the system according to the disclosure diversify, the server 300 according to the disclosure may further define new context types and dynamically expand new service modes corresponding thereto. In addition, a plurality of preset context types and service modes may be operated by being merged into a single integrated intelligent service category according to load balancing or operational policies of the system. Conversely, a particular type may be diversified and operated according to detailed contexts. Therefore, it should be noted that respective types (Types 0 to 4) and service functions corresponding thereto, as exemplified in the specification, merely represent an example of classification to help understanding of the disclosure, and the technical scope of the disclosure is not limited by particular names, numbers, or fixed mapping relationships.

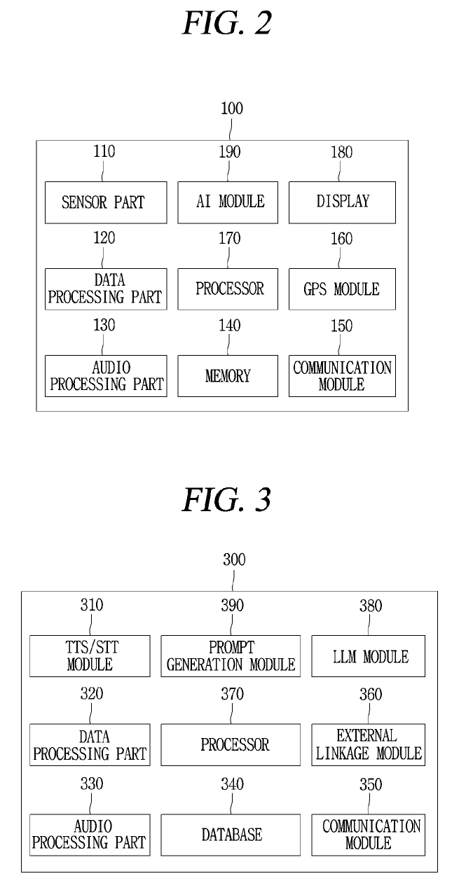

FIG. 2 is a block diagram of the user terminal according to the disclosure.

Referring to FIGS. 1 and 2, the user terminal 100 according to the disclosure may be configured to include at least a sensor part 110, a data processing part 120, an audio processing part 130, a memory 140, a communication module 150, a global positioning system (GPS) module 160, a processor 170, a display 180, and an AI module 190. The components may transmit and receive data to/from each other through a bus or other electrical connection elements, and may be operably connected to each other under control by the processor 170.

The sensor part 110 is an integrated detection unit configured to detect a change in physical states of the vehicle and a driver, and may perform motion detection and vehicle status and bio-signal detection functions depending on detection purposes.

In an embodiment, the sensor part 110 may include an inertial measurement unit (IMU) to detect in real time whether the vehicle 101 is suddenly decelerated, impacted, or overturned. In addition, the sensor part 110 may collect an airbag deployment signal and tire pressure information by interoperating with an internal network of the vehicle to cross-verify whether an accident has occurred. In addition, the sensor part 110 may measure a bio-signal of the driver to determine consciousness and an emergency urgency level of the driver. Data collected from each sensor may be transmitted to the data processing part 120, undergo synchronization and noise filtering processes, and then, be used as input data for context determination by the AI module 190.

The data processing part 120 may refer to a preprocessing module configured to process data (raw data) collected from the sensor part 110 into a form suitable to be processed by the AI module 190.

In an embodiment, the data processing part 120 may apply a low-pass filter or Kalman filter algorithm to remove noise generated during driving and extract only meaningful impact signals. Additionally, the data processing part 120 may ensure data consistency by correcting or interpolating a sampling rate based on timestamps of heterogeneous sensor data collected at different intervals. In addition, the data processing part 120 may normalize the collected data and convert the normalized data into a vector or tensor form that meets an input specification of the AI module 190, thereby optimizing computational efficiency. Data obtained by such preprocessing may be transmitted to the AI module 190 and used as key input data for classifying an accident type and determining an emergency urgency level.

The audio processing part 130 may function to convert an analog voice signal input through a microphone into a digital signal. To do so, the audio processing part 130 may be configured to include a digital signal processor (DSP) configured to extract voice data and acoustic features through a preset algorithm.

In an embodiment, the audio processing part 130 may function to convert a voice signal into text data using an STT model stored in the memory 140. At the same time, the audio processing part 130 may analyze input voice waveforms in a frequency domain or a time domain to calculate acoustic feature vectors including a tone, intensity, frequency variation, amplitude variation, and a speech rate. Then, the audio processing part 130 may be configured to transmit the calculated acoustic feature vectors to the AI module 190.

Additionally, the audio processing part 130 may include a function of converting text data into a synthetic voice signal by utilizing a TTS model stored in the memory 140. In detail, the audio processing part 130 may convert a response message in a text format received from the communication module 150 or the AI module 190 into a synthetic voice signal through the TTS model. At this time, the audio processing part 130 may identify a voice identifier received from the server 300, and synthesize voice by applying personal voice features corresponding to the voice identifier to parameters of the TTS model. Afterwards, the audio processing part 130 may control the synthetic voice signal, obtained by the converting, to be output to a speaker via a digital-to-analog converter (DAC).

The memory 140 may refer to a storage medium configured to store data, programs, and algorithms needed for operation of the user terminal 100. In an embodiment, the memory 140 may be configured to include at least one of various types of non-volatile or volatile memory, such as flash memory, random access memory (RAM), and read-only memory (ROM).

Additionally, the memory 140 may function to temporarily or permanently store programs or applications for control by the processor 170, or input/output data. In an embodiment, the memory 140 may store data of an NTN map (or offline map) including road networks and terrain information to prepare for contexts in which network connection is not available. This allows a terminal to identify geographical environment information even in communication dead zones.

In addition, the memory 140 may store a pre-trained artificial intelligence model and weight parameters needed to drive the AI module 190 to be described later. This allows the memory 140 to provide an environment in which the terminal may independently perform on-device operations without communication with an external server.

The GPS module 160 may refer to a positioning device configured to receive a signal from at least one global navigation satellite system (GNSS), and calculate current location coordinates (latitude, longitude, altitude, and the like) and a movement speed of the terminal in real time. In an embodiment, the GPS module 160 may be configured to comprehensively support various global satellite navigation systems, including a GPS, a global navigation satellite system (GLONASS), Galileo, BeiDou, etc.

Additionally, the GPS module 160 may include a function of generating uninterrupted location information by performing dead reckoning through interoperating with IMU data of the sensor part 110 to ensure precise positioning in dead zones where satellite signal reception is difficult, such as tunnels or underground parking lots.

The GPS module 160 operates independently regardless of connection to TN communication. In particular, when an emergency context based on satellite communication occurs, the GPS module 160 may acquire precise coordinate information about an accident location and transmit the precise coordinate information to the server 300 or the emergency response center 410.

Meanwhile, the GPS module 160 and the memory 140 may interoperate with each other to perform context awareness based on a location of the terminal. In an embodiment, the processor 170 may match current coordinates of the terminal tracked in real time through the GPS module 160 with NTN map data stored in the memory 140. This allows the processor 170 to determine a specific geographical environment such as whether the vehicle is currently on a highway or in a mountainous area. Such location information may be used as an important basis for determining an urgency level in a context awareness process to be described later.

The AI module 190 may refer to an on-device AI processing device activated by loading an AI model stored in the memory 140 and configured to comprehensively determine a context based on collected multimodal data. The AI module 190 may be implemented as a separate neural network processing unit (NPU) or equipped as a type of a software algorithm inside the processor 170. In addition, the AI module 190 may use a lightweight model to enable independent inference even when network connectivity is interrupted.

In an embodiment, the AI module 190 may perform multimodal context analysis. In detail, the AI module 190 may integrate and analyze text data from the audio processing part 130, impact data from the sensor part 110, and geographical environment information. This allows the AI module 190 to classify a corresponding context into at least one of the context types described above and, in correspondence with this, calculate an urgency level. In addition, the AI module 190 may perform a function of analyzing a psychological state of the driver. To perform this function, the AI module 190 may infer the psychological state by analyzing acoustic features such as a pitch, a tremor, and a speech rate of a voice waveform. For example, the AI module 190 may determine a severe voice tremor as a 'panic' state and unclear speech as a 'decreased consciousness' state. Such psychological state information may be included as metadata in a rescue request message.

Further, the AI module 190 may perform text summarization or compression suitable for a satellite communication environment. The AI module 190 may reconstruct a sentence by removing unnecessary prepositions or redundant expressions from the text data and extracting only core keywords. The AI module 190 may be configured to minimize a size of a data packet to increase a transmission success rate through such an intelligent compression process.

The communication module 150 may mean a hybrid communication interface configured to support both TN communication and NTN communication.

In an embodiment, the communication module 150 may be configured to include a first communication modem and a second communication modem which are physically or logically separate from each other. In this regard, the first communication modem may refer to a broadband mobile communication modem configured to communicate with a terrestrial base station, such as long-term evolution (LTE) or fifth-generation new radio (5G NR). In addition, the second communication modem may refer to a satellite-dedicated modem (e.g., an NR-NTN or an IoT-NTN modem) configured to perform direct communication with a low Earth orbit (LEO) or geostationary Earth orbit (GEO) satellite.

The processor 170 may control the communication module 150 to select a modem suitable for a context. For example, in urban areas where strength of a terrestrial network signal is equal to or higher a threshold value, the first communication modem may be activated to maintain high-speed communication. On the other hand, when it is determined that an accident location is in a terrestrial network dead zone such as a remote mountainous area or sea or when an antenna of the first communication modem is damaged due to an impact of an accident, and thus, connection cannot be performed, the processor 170 may immediately activate (wake-up) the second communication modem to establish a satellite link. Additionally, when moving to the NTN zone, the processor 170 may control a time point of data transmission to be delayed or a transmission format to be dynamically switched according to urgency as described above.

The display 180 may refer to an input/output device configured to provide visual information to a user and receive a touch input. In terms of hardware, the display 180 may function to convert a video signal, a data signal, etc. to generate a driving signal.

In an embodiment, the display 180 may visually output system state information under control by the processor 170. In detail, the display 180 may display a first network indicator indicating a connection state of TN communication and a second network indicator indicating a connection state of NTN communication, respectively. At this time, an indicator corresponding to a communication method currently selected and activated by the processor 170 may be visually distinguished from a deactivated indicator through a color, a size, a highlight effect, or the like.

Additionally, the display 180 may display a transmission progress state of the text data or the voice packet data and a satellite connection strength, etc. The display 180 may be configured to render a graphical user interface (GUI) corresponding to a context type (Types 0 to 4) identified by the processor 170. For example, the display 180 may display a map including a current location of the vehicle 101 based on location information of the GPS module 160 and NTN map data of the memory 140. Alternatively, the display 180 may output an image of an emergency response guide and text data corresponding thereto.

In addition, when a response message received from the server 300 includes a voice identifier, the display 180 may display a visual indicator (e.g., a voice profile icon or animation) indicating that the corresponding response message is being played back in personal voice of a sender (or the user). Additionally, the display 180 may support a function of converting the received response message into a native language of the user to outputting the converted response message under control by the processor 170.

The processor 170 may refer to a central processing unit configured to control overall operation of the user terminal 100 and perform operations. The processor 170 may be configured to determine an emergency context by analyzing data collected from each module and control generation of the text data or the voice packet data. In terms of hardware, the processor 170 may be implemented as an application processor (AP), a central processing unit (CPU), or a microcontroller (MCU).

In detail, when a physical impact signal equal to or greater than a threshold value is input from the sensor part 110, the processor 170 may recognize the physical impact signal as an interrupt signal, and control a wake-up signal to be applied to the GPS module 160 and the AI module 190 which have been in a standby mode. Additionally, the processor 170 may receive an emergency urgency level determination result and a TN network connection failure signal each output from the AI module 190, and instruct a communication path to be immediately switched to a satellite modem. Further, the processor 170 may perform integration control of identifying a context type of the received response message, and generating and transmitting video and audio data signals, corresponding to the context type, to the display 180 and the audio processing part 130.

FIG. 3 illustrates a block diagram of the AI assistant server according to the disclosure.

Referring to FIGS. 1 to 3, the AI assistant server 300 according to the disclosure may be configured to include at least a TTS/STT module 310, a data processing part 320, an audio processing part 330, a database 340, a communication module 350, an external linkage module 360, a processor 370, an LLM module 380, and a prompt generation module 390. The components described above may transmit and receive data with each other through a bus or other electrical connection elements, and may be operably connected to each other under control by the processor 370.

The TTS/STT module 310 may refer to an engine configured to perform server-based high-performance speech-to-text conversion and dialogue processing functions based on a signal transmitted from the audio processing part 330.

In an embodiment, the TTS/STT module 310 may convert voice packet data transmitted from the user terminal 100 into high-precision text data through a speech-to-text (STT) function. In particular, the TTS/STT module 310 may be configured to secure a high recognition rate even with voice in an emergency context in which noise is mixed or speech is unclear, by utilizing large-capacity computational resources of a server.

In addition, the TTS/STT module 310 may have an interactive TTS/STT function equipped therein. This allows to synthesize voice in which intonation and emotion appropriate for a context are reflected, as well as simple text reading. In an embodiment, the TTS/STT module 310 may extract a user-specific voice identifier stored in the database 340 and, based on the voice identifier, generate a voice signal in which unique personal voice features of the user 102 are reflected and transmit the voice signal to the emergency response center 410, etc.

Furthermore, the TTS/STT module 310 may support multilingual interpretation and translation functions. This allows to overcome a language barrier by performing real-time voice conversion between a native language of the user and a local language when an accident occurs or a service is reserved overseas.

The data processing part 320 may refer to a preprocessing module configured to process text data or voice packet data received through the communication module 350. In detail, the data processing part 320 may perform a decompression function to restore a received packet to an original data form. Afterwards, the data processing part 320 may analyze a header and a payload of received data to separate multimodal data such as the context types (Types 0 to 4), a sensor value, and audio data. In addition, the data processing part 320 may function to normalize the separated multimodal data into a standard format which may be processed by the processor 370 or the LLM module 380.

The audio processing part 330 may refer to a signal processing device configured to set and manage a voice conversation environment of the server 300. In an embodiment, the audio processing part 330 may apply acoustic echo cancellation (AEC) and noise reduction algorithms to a received voice signal to maximize a voice recognition rate, and function as a gateway configured to convert generated synthetic voice data into a codec suitable for an external public switched telephone network (PSTN) or a voice over Internet protocol (VoIP) and transmit the converted synthetic voice data.

The database 340 may refer to a storage medium configured to store data and algorithms needed for operation of the server 300. In an embodiment, the database 340 may store a personal voice identifier including unique acoustic feature information of each user, and a corresponding voice synthesis model. Additionally, the database 340 may store a prompt template for each context type used by the prompt generation module 390 and application programming interface (API) authentication information for interfacing with an external service.

The communication module 350 may mean a hybrid communication interface configured to support both TN communication and NTN communication. In detail, the communication module 350 may include a satellite network gateway interface for communication with the user terminal 100 and an external network interface for interfacing with external services. The communication module 350 may receive the text data or the voice packet data transmitted via a satellite or retransmit a processed response message.

The external linkage module 360 may function as a gateway configured to transmit a result of processing by the server 300 to an external service and integrate the result.

In an embodiment, the external linkage module 360 may transmit data or interoperation queries to the emergency response center 410, a telephone reservation center (not shown), or an external search engine, depending on an identified context type.

The LLM module 380 may refer to a computational device configured to perform unstructured data analysis by interoperating with the LLM 301 located outside. The LLM module 380 may transmit a query, having received from the prompt generation module 390, to the LLM 301 and transmit a received analysis result to the processor 370.

The prompt generation module 390 may refer to a software engine configured to analyze standardized terminal information received from the data processing part 320, and dynamically generate a 'context-aware prompt' based on a natural language to enable the LLM module 380 to perform optimal inference. In detail, the prompt generation module 390 may reconstruct heterogeneous multimodal data, such as text, sensor values, and bio-signals each transmitted from the terminal, into a single integrated context that may be understood by the LLM 301.

The processor 370 may refer to a central processing unit configured to control overall operation of the server 300. In detail, the processor 370 may analyze header information of received data to identify a context type and selectively activate the LLM module 380, the TTS/STT module 310, and the external linkage module 360 according to the identified type to control a service to be provided by branching into each operation mode such as emergency call, information search, and reservation.

Meanwhile, the user terminal 100 and the AI assistant server 300 each shown in FIGS. 1 to 3 are merely an embodiment of the disclosure. Therefore, some of the components illustrated herein may be integrated, added, or omitted depending on specifications of the user terminal 100 and AI assistant server 300 which are actually implemented.

That is, configuration may be made such that two or more components may be integrated into one component, or one component may be divided into two or more components, as needed. In addition, functions performed in each block are intended to describe an embodiment of the disclosure, and specific operations or devices thereof do not limit the scope of the disclosure.

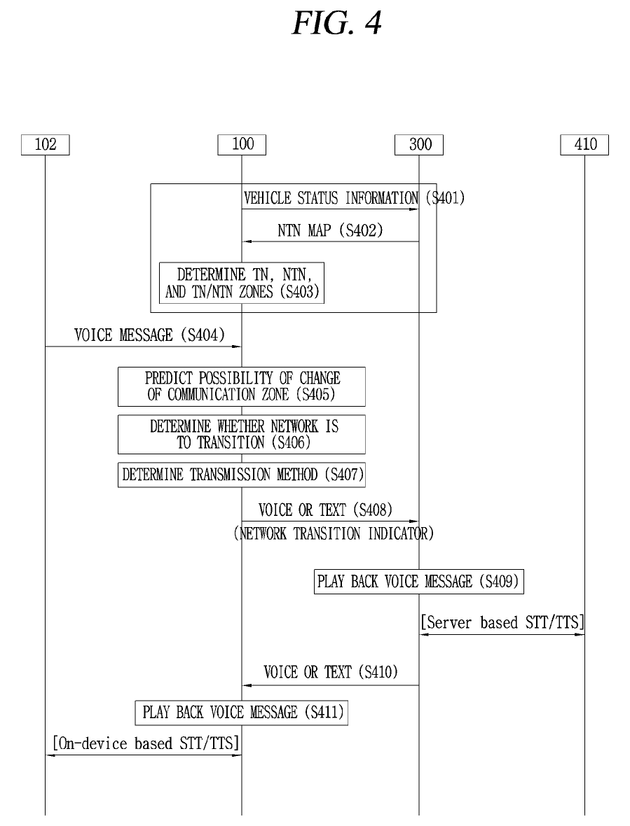

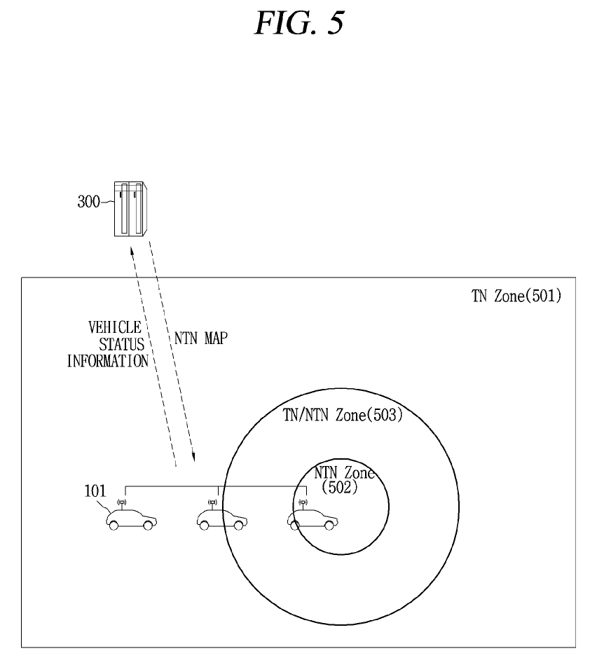

Hereinafter, a method of transmitting and receiving voice messages through network transition prediction according to the disclosure will be described. In this regard, FIG. 4 is a flowchart of operation between respective modules of the user terminal, the server, and the emergency response center, each configured to perform transmission and reception of voice messages through the network transition prediction according to the disclosure. In addition, FIG. 5 illustrates an embodiment in which a TN zone, an NTN zone, and a TN/NTN zone according to the disclosure are generated.

Referring to FIGS. 1 to 5, transmission and reception of voice messages through the network transition prediction according to the disclosure may be performed by the processor 170 of the user terminal 100 and the processor 370 of the server 300.

The user terminal 100 according to the disclosure may be configured to transmit a voice message from a vehicle 101. As previously mentioned, the user terminal 100 may be the vehicle 101 or implemented integrally with the vehicle 101.

In an embodiment, the user terminal 100 may include a microphone configured to receive a voice message of the user 102. The microphone may be implemented to be included in the audio processing part 130 of FIG. 2, or configured to collect the user's voice message by being operably connected to the audio processing part 130. Here, the voice message may include voice spoken by the user 102.

Additionally, the user terminal 100 may include an antenna and the communication module 150 configured to enable terrestrial network (TN) communication and non-terrestrial network (NTN) communication using a satellite. Here, the antenna may include an antenna configured to measure a TN signal and an NTN signal, and according to an embodiment, may further include an antenna configured to measure a GPS signal.

Additionally, the processor 170 of the user terminal 100 may be operably connected to the communication module 150, and configured to transmit the voice message of the user 102 using at least one communication method among the TN communication and the NTN communication.

In this regard, the processor 170 may predict a communication zone corresponding to an expected location on a driving path of the user terminal 100 based on a TN signal or an NTN signal each collected through the antenna. Additionally, according to an embodiment, the processor 170 may predict a communication zone corresponding to an expected location of the user terminal 100 further based on a GPS signal in addition to the TN signal or the NTN signal. Here, the expected location on the driving path may refer to a point that the vehicle 101 is predicted to reach after a preset threshold time. This may be coordinate information at a future time point calculated based on at least one from among a current location, a current driving speed, and a driving direction of the vehicle 101.

Then, the processor 170 may determine a transmission protocol or a data format of the voice message based on a result of the prediction. Here, the transmission protocol may refer to either the TN communication via a terrestrial base station or the NTN communication using a satellite. Additionally, the data format may refer to a structure in which a data body including a voice packet or text data is combined with a flag field notifying of a scheduled network transition.

Then, the processor 170 may transmit, to the server 300, a voice message constructed according to the determination. That is, the processor 170 may construct a voice message by generating a data body and setting a flag field according to the determined data format, and transmit the constructed voice message through a communication path according to the determined transmission protocol.

Meanwhile, the communication zone according to the disclosure may be classified into a TN zone 501, an NTN zone 502, and a TN/NTN zone 503. The TN zone 501 may refer to an area in which a communication service via a TN is available, and the NTN zone 502 may refer to an area in which an NTN communication service via a satellite is available. The TN/NTN zone 503 may refer to a network transition preparation area between TN communication and NTN communication.

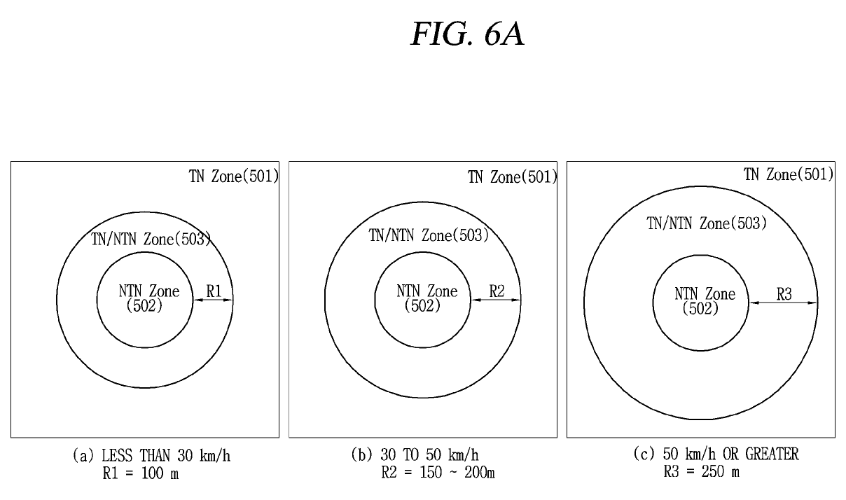

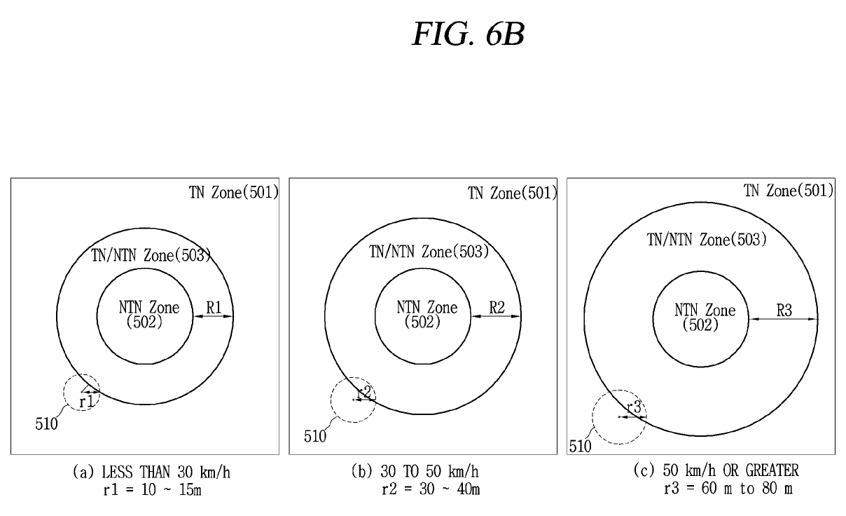

In particular, the processor 170 according to the disclosure may variably adjust a coverage boundary of the TN/NTN zone 503 in proportion to a driving speed of the vehicle 101 in which the user 102 of the user terminal 100 is riding. In this regard, a method of setting a communication zone and adjusting a boundary will be described in detail later with reference to FIGS. 6A and 6B.

Referring to FIG. 4, the processor 170 may transmit (S401) vehicle status information to the server 300 according to a preset interval. The vehicle status information may include at least one from among signal information, RAT, location information, speed information, and a GPS threshold value.

Then, the processor 170 may receive (S402) an NTN map from the server 300 and, based on an NTN map and a current location and a driving speed of the vehicle 101, may determine (S403) the TN zone 501, the NTN zone 502, and the TN/NTN zone 503 on a current driving path.

Operations S401 to S403 described above may be performed periodically to dynamically reflect a communication environment and a moving state of the vehicle 101, each changing in real time, and may be repeated approximately every 2 seconds in an embodiment.

In this regard, referring to FIG. 5, the vehicle 101 according to the disclosure may periodically transmit status information of the vehicle 101 to the server 300. In an embodiment, the vehicle 101 may upload vehicle status data at an interval of about 2 seconds. The server 300 may generate and update an NTN map based on vehicle status information collected from a plurality of vehicle terminals. Additionally, the server 300 may share the generated and updated NTN map with each vehicle 101.

Here, the 'vehicle status information' may include at least one from among signal information, RAT, location information, speed information, and a GPS threshold value. The signal information is a measurement value of a signal on a communication network, the measurement value being obtained by an antenna of the vehicle 101, and may include signal strength and quality indicators such as NTN reference signal received power (RSRP) and a TN signal-to-noise (S/N). The RAT may be used to identify RAT to which the vehicle 101 is currently connected, among the TN and the NTN.

Additionally, the location information and the speed information represent geographical coordinates and a driving speed of the vehicle 101, respectively measured by a GPS, and may be fundamental data for the server 300 or the vehicle 101 to dynamically adjust a size of the TN/NTN zone 503 or predict a time point of network transition. The GPS threshold value is a reference for positioning accuracy, and may be utilized to define an error between an actual travel distance and a GPS measurement value and verify whether positioning accuracy needed by an NTN service is satisfied.

Additionally, the NTN map may refer to a region-based communication environment map generated and managed by the server 300 based on the vehicle status information received from each vehicle 101. The processor 170 of the user terminal 100 may dynamically determine the TN zone 501, the NTN zone 502, and the TN/NTN zone 503 on a current driving path based on the NTN map shared by the server 300.

In detail, the processor 170 may identify the NTN zone 502 located on a driving path based on the NTN map received from the server 300. In an embodiment, the NTN zone 502 may be set as an area that satisfies preset NTN communication quality conditions when NTN RSRP is equal to or greater than a predetermined threshold value, positioning accuracy based on a GPS threshold value is secured, and a TN S/N condition is equal to or less than a certain level.

Additionally, the TN/NTN zone 503 may mean a buffer area in which the TN communication and the NTN communication are available simultaneously, and network transition between the TN communication and the NTN communication is prepared. The processor 170 according to the disclosure may variably determine a spatial range of the TN/NTN zone 503 based on a driving speed of the vehicle 101.

The TN zone 501 may mean a general area in which a TN communication service is available. In an embodiment, the TN zone 501 may be defined as a remaining area that does not correspond to conditions of the NTN zone 502 and the TN/NTN zone 503 each defined above.

Referring back to FIG. 4, the processor 170 may receive (S404) a voice message from the user 102 through a microphone of the vehicle 101 or the user terminal 100.

When receiving the voice message, the processor 170 according to the disclosure may determine a transmission protocol or a data format of the voice message according to a communication zone in which the user terminal 100 is currently located.

In an embodiment, when a current location of the user terminal 100 is in the NTN zone 502, the processor 170 may determine a transmission protocol of the voice message as NTN communication using the satellite 200 and control a data body to be constructed as text data. Accordingly, the processor 170 may control the voice message to be converted into text data and the text data to be transmitted to the server 300 via the satellite 200. At this time, the processor 170 may perform on-device STT conversion in the user terminal 100 to convert the voice message into the text data. Additionally, the processor 170 may further perform summarization or compression of the text data in consideration of a limited bandwidth of satellite communication. In addition, the processor 170 may display, on the display 180 of the user terminal 100, an NTN network indicator indicating that the NTN communication is activated. The NTN network indicator may include an NTN connection state and signal strength.

In another embodiment, when a current location of the user terminal 100 is in the TN zone 501, the processor 170 may determine a transmission protocol of the voice message as TN communication through a terrestrial network base station and control a data body to be maintained in a format of voice packet data. Accordingly, the processor 170 may control the voice packet data format to be maintained in the voice packet data format, instead of being converted into text, and transmitted to the server 300 via the terrestrial network base station. Additionally, in consideration of a total capacity of the voice packet data or a length of a data stream, the processor 170 may divide the voice packet data into a plurality of pieces of data or compress the voice packet data to transmit the divided or compressed voice packet data. In addition, the processor 170 may display, on the display 180 of the user terminal 100, a TN network indicator indicating that the TN communication is being used. The TN network indicator may include a TN connection state and a signal strength.

In another embodiment, when a current location of the user terminal 100 is in the TN/NTN zone 503, the processor 170 may transmit the voice message by selecting at least one communication method among TN communication and NTN communication based on network quality of service (QoS) of the TN communication and the NTN communication. For example, the processor 170 may determine a transmission path on which a voice messages is to be transmitted, based on latency, packet loss, and a signal-to-noise ratio (SNR) of each communication.

At this time, the processor 170 may display, on the display 180 of the user terminal 100, a first network indicator and a second network indicator indicating connection states and signal strength of the TN communication and the NTN communication, respectively. Here, the first and second network indicators may be displayed simultaneously, and the first network indicator corresponding to a selected communication method may be displayed to be visually distinguished from the second network indicator. For example, the processor 170 may emphasize an icon corresponding to a currently activated communication path by inverting a color or increasing brightness of the icon, and at a time point when a network transition occurs, apply a blinking effect or a change in a border thickness to a corresponding indicator to cause the user to intuitively recognize a change in a communication state.

Additionally, the processor 170 according to the disclosure may analyze the voice message to determine occurrence of an emergency context and an emergency urgency level. Depending on a result of the determination, the processor 170 may transmit the voice message by selecting at least one communication method among the TN communication and the NTN communication.

In this regard, when the emergency urgency level is equal to or greater than a preset threshold value, the processor 170 may control a text message corresponding to the voice message to be transmitted via the NTN communication. On the other hand, when the emergency urgency level is below the preset threshold value, the processor 170 may control transmission of the voice message via the NTN communication to be delayed to efficiently manage NTN communication resources. In detail, in a case of a low-level urgency context, the processor 170 may temporarily suspend message transmission by adjusting transmission scheduling to prevent traffic load on an NTN network. Then, the processor 170 may manage the message transmission by deferring the message transmission until a time point at which the vehicle 101 re-enters the TN zone 501 in which a terrestrial network connection is available, or lowering a transmission priority of the corresponding message.

Additionally, the processor 170 may predict (S405) a possibility of a change of a communication zone within a preset threshold time, based on at least one among an NTN map, a vehicle location, and a driving path each received from the server 300.

Here, the threshold time may mean a time expected to be needed from when the user terminal 100 transmits a message to the server 300 until a response message is received from the server 300. In other words, the threshold time may be set as a reference time for determining whether network transition according to a change in a communication zone occurs before the response message is received.

As described above, the processor 170 according to the disclosure may obtain communication zone information including the TN zone 501, the NTN zone 502 and the TN/NTN zone 503 on a current driving path based on a map shared from the server 300. Additionally, the processor 170 may analyze communication zone information, the current driving path, and a vehicle speed to calculate a time point at which a communication zone in which the vehicle 101 is currently located overlaps another communication zone adjacent thereto at a preset interval. Then, the processor 170 may predict a possibility of a change in a communication zone within the threshold time depending on driving of the vehicle 101, based on the time point of the overlapping.

Then, the processor 170 may determine (S406), based on a result of the prediction, whether to transition a network between the TN communication and the NTN communication within the threshold time.

In particular, in the TN/NTN zone 503 in which both the TN communication and the NTN communication are available, the processor 170 may select an optimal communication path among a plurality of available communication paths. In an embodiment, the processor 170 may select, from among available networks, a path having lowest latency and highest connection stability with a high priority. For example, when an emergency urgency level is equal to or greater than a preset criterion, the processor 170 may control to select both communication methods simultaneously or select a fastest path with a high priority.

When it is determined that the network transition between the TN communication and the NTN communication within the threshold time is to be performed in operation S406, the processor 170 may add, to the voice message, a network transition indicator notifying of a scheduled network transition, and transmit the voice message to which the network transition indicator is added.

In an embodiment, when the vehicle 101 currently located in the TN zone 501 is predicted to enter the NTN zone 502 while driving and a network transition is determined, the processor 170 may set the network transition indicator to TRUE and add the set network transition indicator to a voice message. After receiving the voice message, the server 300 may recognize in advance that, even when the user terminal 100 is currently connected to a TN environment, a network transition is to occur after the preset threshold time. Accordingly, when transmitting a response message to the user terminal 100 after the preset threshold time, the server 300 may transmit the response message via an NTN route scheduled for the transition to ensure a seamless conversation between a listener and a speaker.

Then, the processor 170 may finally determine (S407) a method of transmitting a voice message based on a result of the determination in operation S406. Here, the determining of the transmission method may mean determination of a transmission protocol or a data format.

In an embodiment, when a TN is being currently used but a transition to an NTN is predicted, the processor 170 may maintain a data format as a voice packet while setting set a network transition indicator to TRUE. On the other hand, when a current TN environment is predicted to be stably maintained, the processor 170 may determine a transmission method such that a voice packet format is maintained and the network transition indicator is set to FALSE or the network transition indicator is not included.

In another embodiment, when an NTN is being currently used but a transition to a TN is predicted, the processor 170 may convert a data format into text data and transmit the converted data format, and set the network transition indicator to TRUE to indicate scheduled returning to the TN. On the other hand, when it is determined that a current NTN environment is to be continued, the processor 170 may maintain the text data format and set the network transition indicator to FALSE or omit the network transition indicator.

Then, the processor 170 may transmit, to the server 300, a voice message constructed according to the determination in operation S407. That is, the processor 170 may generate a data body including voice data or text data and construct a voice message by setting a network transition indicator flag field. Then, the processor 170 may transmit (S408) the voice data or the text data to the server 300 via a TN or NTN communication path.

At this time, the processor 170 may include, in the voice message, a voice identifier corresponding to unique acoustic information of the user 102. Additionally, as a result of the prediction described above, when a possibility of network transition is equal to or greater than a threshold value, the processor 170 may set the network transition indicator to TRUE and add the set network transition indicator to data. On the other hand, when it is determined that a possibility of a network transition is low or a current communication environment is to be maintained, the processor 170 may transmit data in a state when the network transition indicator is set to FALSE or an indicator flag is not included.

Meanwhile, when receiving a voice packet or text data, the server 300 may perform a process (S409) of playing back the voice message of the user 102 or transmitting the voice message to the emergency response center 410.

In an embodiment, when the vehicle 101 is located in the NTN zone 502 and receives the text data, the server 300 may perform server-based STT/TTS to support a voice-based conversation with the emergency response center 410. At this time, when converting text into voice based on a voice identifier included in the data, the server 300 may reflect unique acoustic features (voice tone, intonation, etc.) of the user 102 to provide the emergency response center 410 with voice similar to actual voice of the user 120. In addition, in some cases, the server 300 may transmit received voice or converted data to the emergency response center 410 to control a message to be immediately played back by a terminal of the corresponding center.

Then, the processor 170 may receive (S410) a response message (voice or text data) transmitted from the emergency response center 410 by the server 300. Then, the processor 170 may play back (S411) the received response message to transmit the response message to the user 102.

In an embodiment, when a current communication environment of the vehicle 101 is the NTN zone 502, the processor 170 may perform on-device based STT/TTS on the received text data to provide a voice-based conversation to the user. This enables to maintain efficient text data-based transmission even in an NTN environment in which a bandwidth is limited, while allowing natural two-way voice communication on an actual user interface.

Hereinafter, an embodiment in which a coverage boundary of the TN/NTN zone is variably adjusted will be described. In this regard, FIG. 6A illustrates an example in which a radius of the TN/NTN zone is dynamically adjusted according to a speed change of the vehicle according to the disclosure. Additionally, FIG. 6B illustrates an example in which a radius of a vehicle area is dynamically adjusted according to a speed change of the vehicle according to the disclosure.

Referring to FIGS. 1 to 6B, adjustment of a coverage boundary of the TN/NTN zone 503 may be performed by the processor 170 of the user terminal 100.

First, referring to FIG. 6A, the processor 170 may variably determine a spatial range of the TN/NTN zone 503 according to a current driving speed of the vehicle 101. In the specification, the TN/NTN zone 503 may be defined as a 'flexible switching ready zone,' which is a buffer area secured in advance to ensure seamless connection at a time point of transition between the TN and the NTN.

In an embodiment, the processor 170 may create and manage a table in which values of a radius (R) for each driving speed are set. In another embodiment, the processor 170 may calculate the values of the radius R for each driving speed in real time based on an NTN map received on-device from the server.

In detail, the processor 170 may be configured to expand radii R1 to R3 of the TN/NTN zone 503 extending from a boundary of the NTN zone 502 as a driving speed of the vehicle 101 increases. This is to sufficiently ensure computation and handover time for network transition even in a high-speed driving environment by setting a range of the flexible switching ready zone to be expanded when a driving speed of the vehicle 101 increases. This allows the processor 170 to minimize a handover failure rate and maintain a stable service.

As described above, the processor 170 may variably set a radius of the TN/NTN zone 503 in proportion to a driving speed of the vehicle 101. For example, as shown in (a) of FIG. 6A, when a driving speed of the vehicle 101 is 30 km/h or less, the radius R1 may be set to about 100m, and as shown in (b) of FIG. 6A, when a driving speed is 30 to 50 km/h, the radius R2 may be set to 150 m to 200 m. In addition, as shown in (c) of FIG. 6A, during driving at a high speed exceeding 50 km/h, the radius R3 may be extended to be equal to or greater than 250 m to secure a sufficient buffer area.

Then, referring to FIG. 6B, the processor 170 of the user terminal 100 may determine a size of a vehicle area 510 according to radii r1 to r3 based on a driving speed of the vehicle 101. Here, the 'vehicle area 510' may refer to a predetermined determination boundary area set with reference to location coordinates of the vehicle 101. The vehicle area 510 may refer to a virtual buffer area for identifying a communication zone where the vehicle 101 is currently located and determining a time point of network transition.

The processor 170 may determine that the vehicle 101 has entered or is located in a corresponding communication zone from a point where the vehicle area 510 overlap respective communication zones (the TN, NTN, and TN/NTN zones 501 to 503).

In an embodiment, the processor 170 may dynamically increase a radius (r) of the vehicle area 510 to the radius r1, r2, or r3, according to a driving speed of the vehicle 101. That is, the processor 170 may set the vehicle area 510 to be expanded when the driving speed of the vehicle 101 increases. This is intended to sensitively detect a time point when the vehicle area 510 overlaps each of the communication zones 501 to 503.

As such, the processor 170 may variably set a radius of the vehicle area 510 in proportion to a driving speed. For example, as shown in (a) of FIG. 6B, when a driving speed of the vehicle 101 is 30 km/h or less, the radius r1 may be set to about 10m to 15m, and as shown in (b) of FIG. 6B, when a driving speed thereof is 30 to 50 km/h, the radius r2 may be set to about 30 m to 40 m. In addition, as shown in (c) of FIG. 6B, in a case of driving at a high speed exceeding 50 km/h, the radius r3 may be set to approximately 60 m to 80 m to ensure a sufficient determination distance even during movement at a high speed.

Meanwhile, the determination of a coverage of the TN/NTN zone 503 or a vehicle area has been described above as being performed by the processor 170 of the user terminal 100, but is not limited thereto. In another embodiment, a coverage of the TN/NTN zone 503 or a vehicle area may be set by the server 300. For example, the server 300 may generate a default radius set value based on a traffic environment, a communication infrastructure state, regional network characteristics, or service policies, and transmit the default radius set value to the user terminal 100. In this case, the processor 170 of the user terminal 100 may use the default radius set value received from the server 300 as an initial value. Additionally, the processor 170 may variably correct and apply the radius according to a driving speed of the vehicle 101, real-time signal quality, or sensor information. That is, a coverage boundary of the TN/NTN zone 503 or a size of a vehicle area may be implemented as a distributed control structure which is initially set by the server 300 and dynamically adjusted by the processor 170 of the user terminal 100.

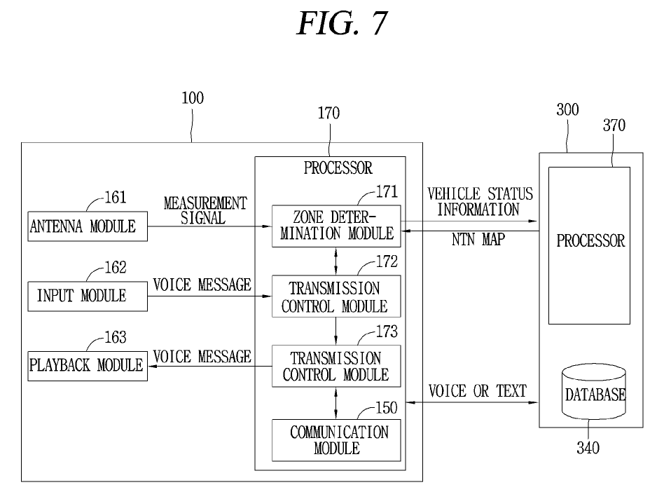

Hereinafter, detailed components of the user terminal configured to perform voice message transmission and reception through the network transition prediction according to the disclosure will be described. In this regard, FIG. 7 illustrates an internal block diagram of the user terminal configured to perform voice message transmission and reception through the network transition prediction according to the disclosure, and an interface of the user terminal with the server.

Referring to FIGS. 1 to 7, the processor 170 of the user terminal 100 according to the disclosure may be configured to include a zone determination module 171, a transmission control module 172, and a conversion module 173 depending on functions.

In this regard, the zone determination module 171 may receive a measurement signal from an antenna module 161, check a real-time channel state, and transmit vehicle status information to the server 300. In correspondence with this, the zone determination module 171 may receive a latest NTN map from the server 300. At this time, the processor 370 of the server 300 may generate an NTN map based on coverage information of each communication network stored in the database 340 and state information collected from terminals, and distribute the NTN map to each terminal. Then, the zone determination module 171 may determine the TN zone 501, the NTN zone 502, and the TN/NTN zone 503 each present on a current driving path, based on the NTN map and a location and a driving speed of the vehicle 101.

Then, the transmission control module 172 may receive a voice message of a user from an input module 162. The transmission control module 172 may predict a possibility of a change in a communication zone within a preset threshold time based on at least one among the NTN map, the vehicle location, and the driving path. In addition, the transmission control module 172 may determine whether a network transition between TN communication and NTN communication is to be performed based on a result of the prediction.

According to a result of the determination, when a voice message is transmitted via the NTN communication, the transmission control module 172 may control the conversion module 173 to convert the voice message into text data. Additionally, the transmission control module 172 may transmit the text data, obtained by the converting, to the server 300 through the communication module 150. On the other hand, when the voice message is transmitted via the TN communication, the voice message may be transmitted to the server 300 through the communication module 150, while maintaining a voice data format without a separate text conversion process.

Then, the processor 170 may receive a voice or text message returned from the server 300 via the communication module 150. In an embodiment, when the text data is received, the conversion module 173 may restore the text data back into voice data through on-device-based conversion. Additionally, the processor 170 may control a voice message, obtained by the restoring, to be output through a playback module 163. When the voice data is received directly from the server 300, the voice data may be played back immediately through the playback module 163 without a conversion process.

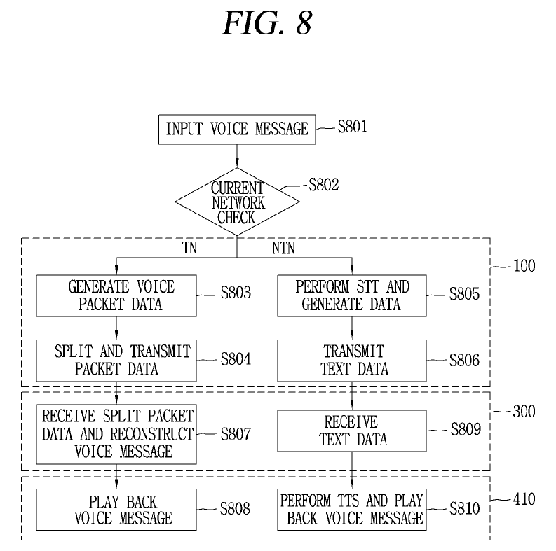

Hereinafter, an embodiment in which transmission and reception of voice messages based on a connection network according to the disclosure are controlled will be described. In this regard, FIG. 8 illustrates a sequence for transmitting and playing back a voice message according to a connected network environment according to the disclosure.

Referring to FIGS. 1 to 8, based on a connection network according to the disclosure, an operation of controlling transmission and reception of voice messages may be performed by the processor 170 of the user terminal 100 and the processor 370 of the server 300.

First, the processor 170 of the user terminal 100 may receive (S801) an input of a voice message from the user 102. Then, the processor 170 may check (S802) whether a network currently connected to the vehicle 101 is a TN or an NTN.

As a result of the checking in operation S802, when the currently connected network is the TN, the processor 170 may determine that a current communication environment allows stable high-speed communication. Accordingly, the processor 170 may generate (S803) voice packet data based on the input voice message. In this regard, the processor 170 may compress a received voice signal using a predetermined voice codec and convert the compressed voice signal into a voice frame in units of a packet.

In an embodiment, the processor 170 may split and transmit the generated voice packet data (S804). In another embodiment, a splitting process may not be performed depending on network service quality (QoS) or a size of the voice packet data.

Meanwhile, as a result of the checking in operation S802, when the currently connected network is the NTN, the processor 170 may determine that a bandwidth is limited or latency may occur in a current communication environment. This may correspond to a case when communication is performed via the NTN in an area not covered by TN coverage.

Accordingly, the processor 170 may perform STT on the input voice message to generate (S805) text data. In this regard, the processor 170 may perform an interactive speech synthesis function using an on-device method. That is, the terminal may be configured to perform a function of converting a user voice input into text data or converting a response in a text format, the response received from the server 300, into synthesized voice and outputting the synthesized voice. This may be particularly useful in an NTN environment when available wireless resources are limited due to characteristics of satellite communication, or when it is difficult to transmit large-volume voice data in emergency contexts such as an emergency rescue.

Then, the processor 170 may transmit the text data obtained by the converting (S806). In an embodiment, the processor 170 may summarize or compress the text data to transmit the text data in consideration of bandwidth constraints and potential latency in the NTN environment. For example, a summary level or a compression rate may be determined differently based on satellite communication link quality, and in a case of an emergency context or low communication quality, a text summary level may be increased or a high compression algorithm may be applied to increase a data transmission success rate.

Additionally, although not illustrated, in the transmission of the voice (S804 or S806) according to the disclosure, not only the voice message of the user 102 but also sensor data or user UI input data may be transmitted together as additional information. The sensor data may include vehicle and driver state data obtained through driving sensors, biometric sensors, cameras, etc. included in the vehicle 101. In addition, the user UI input data may include an emergency call function via a button or a touch UI.

Meanwhile, the AI assistant server 300 according to the disclosure may receive voice packet data in a TN environment and receive text data in an NTN environment.

In an embodiment, the server 300 may receive voice packet data from the vehicle 101 in the TN environment and reconstruct a voice message based on the split voice packet data (S807). In this regard, the processor 370 of the server 300 may reassemble the split voice packet data received from the vehicle 101 to restore the voice packet data. Additionally, the processor 370 may generate a final voice message by decompressing data having been compressed through a codec or additional compression at the user terminal 100. Then, the server 300 may control the voice message reconstructed in operation S807 to be transmitted to the emergency response center 410 to play back a user voice message (S808).

In another embodiment, the server 300 may receive text data (S809) from the user terminal 100 in the NTN environment. Then, the server 300 may control the received text data to be transmitted to the emergency response center 410 to play back a TTS-based voice message at the emergency response center 410 (S810).

Further, the server 300 according to the disclosure may perform a voice-based conversation with the emergency response center 410 by directly performing server-based interactive STT/TTS based on the received text data. Here, the “server-based interactive STT/TTS” may refer to a method in which generation of an emergency response guidance sentence, voice synthesis, and conversation flow control are performed integrally by the server 300. As a result, even in an emergency context in which it is difficult for a driver to make a call due to physical injury or other reasons, the server 300 may immediately initiate voice guidance or perform connection to a rescue agency on behalf of the driver, thereby providing an intelligent emergency response service.

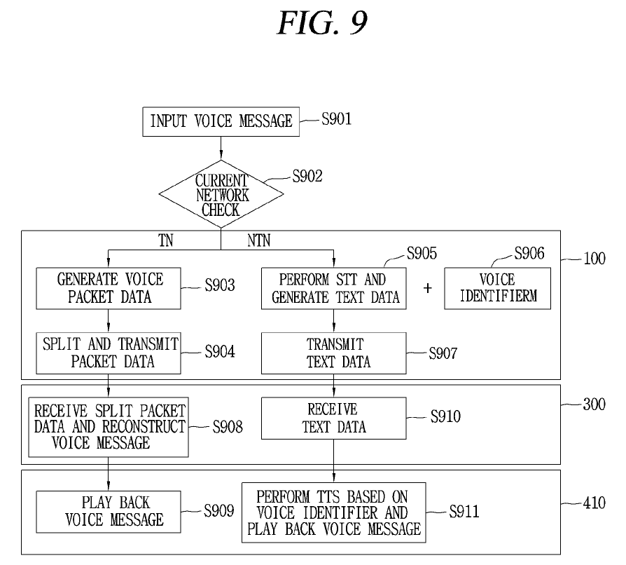

Hereinafter, another embodiment in which transmission and reception of voice message are controlled based on a connection network according to the disclosure will be described. In this regard, FIG. 9 illustrates a sequence for transmitting and playing back a voice message based on a voice identifier according to the disclosure.

Referring to FIGS. 1 to 9, an operation of controlling transmission and reception of voice messages based on a connected network according to the disclosure may be performed by the processor 170 of the user terminal 100 and the processor 370 of the server 300.

First, the processor 170 of the user terminal 100 may receive (S901) an input of a voice message from the user 102. In correspondence with this, the processor 170 may check (S902) whether a network currently connected to the vehicle 101 is a TN or an NTN.

As a result of the checking in operation S902, when the currently connected network is a TN, the processor 170 may generate voice packet data (S903) based on the input voice message. Then, the processor 170 may split and transmit the generated voice packet data (S904).

Meanwhile, as a result of the checking in operation S902, when the currently connected network is an NTN, the processor 170 may perform STT on the input voice message to generate text data (S905).

In an embodiment, the processor 170 may extract acoustic features of a speaker from an input voice signal during a process of the performing of the STT and obtain a voice identifier for identifying personal voice features by analyzing the extracted acoustic features (S906).

Here, the "voice identifier" may refer to voice-based identification data generated based on acoustic feature information obtained from voice data of a particular user. The voice identifier may have a data structure representing the voice features of the speaker separately from content of voice. In an embodiment, the voice identifier may include one from among an acoustic feature vector extracted from the input voice signal, speaker embedding, or a combination thereof.

In addition, the acoustic feature vector or data of the embedding may be configured to reflect frequency components, temporal characteristics, and energy distribution of the voice signal. In detail, the voice identifier may include one or more selected from fundamental frequency information of the voice signal, formant distribution information, spectral energy distribution information, speech rate information, speech duration information, intonation and stress change information, and Mel-frequency cepstral coefficients (MFCC).

Meanwhile, in the embodiment, the processor 170 may selectively determine a method of generating the voice identifier according to a computational resource state or a power resource state (hereinafter, system resource state) of the user terminal 100.

For example, when the system resource state of the user terminal 100 is equal to or below a preset threshold value, the processor 170 may select a voice identifier most similar to input voice through similarity matching between a plurality of predefined representative voice identifiers and the input voice. In an embodiment, the plurality of representative voice identifiers may include, e.g., sixteen voice identifiers, but may be variably set according to the system resource state, system settings, or a communication environment of the user terminal 100. On the other hand, when the system resource state of the user terminal 100 is equal to or greater than a threshold value, the processor 170 may generate a personal voice identifier in which personal voice features of each user are reflected, by using the acoustic features extracted from the input voice signal.

The user terminal 100 according to the disclosure may use an artificial intelligence model which is on-device and pre-trained to identify voice features corresponding to the user's voice message. In this regard, the artificial intelligence model may be pre-trained using acoustic features extracted from a plurality of pieces of training voice input data as training data. Then, the artificial intelligence model may be configured to receive an input of the acoustic features extracted during a process of the STT performance and output the voice identifier in which the personal voice features are reflected.

Then, the processor 170 may attach the voice identifier generated as a result of the STT to converted text data and transmit a result of the attachment (S907). In an embodiment, the processor 170 may summarize or compress the text data and encode the voice identifier into an efficient data format to perform the transmission, in consideration of bandwidth constraints and potential latency in the NTN environment.

Meanwhile, the AI assistant server 300 according to the disclosure may receive voice packet data in the TN environment and receive text data in the NTN environment.

In an embodiment, the server 300 may receive voice packet data from the vehicle 101 in a TN environment, and reconstruct and generate a voice message based on the split voice packet data (S908). Then, the server 300 may control the voice message reconstructed in operation S908 to be transmitted to the emergency response center 410 to play back a user voice message (S909).

In another embodiment, the server 300 may receive (S910) the text data, to which the voice identifier is attached, from the user terminal 100 in the NTN environment. Then, the server 300 may transmit the text data and the attached voice identifier to the emergency response center 410. In correspondence with this, the emergency response center 410 may perform TTS playback (S911) by reflecting personal voice features specified by the attached voice identifier in the received text data.

In some cases, the server 300 according to the disclosure may perform a voice-based conversation with the emergency response center 410 by performing server-based interactive STT/TTS based on the received text data. In this regard, the server 300 may perform voice-based conversations with the emergency response center 410 and perform TTS playback by reflecting personal voice features specified by a voice identifier added to the received text data.

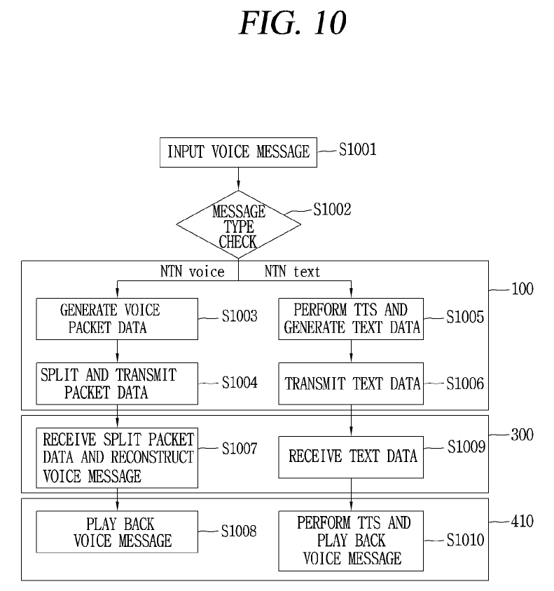

Hereinafter, an embodiment in which transmission and reception of voice messages are controlled according to a message type in the NTN environment according to the disclosure will be described. In this regard, FIG. 10 illustrates a sequence for transmitting and playing back a voice message according to a message type according to the disclosure.

Referring to FIGS. 1 to 10, in the NTN environment according to the disclosure, an operation of controlling voice message transmission and reception according to a message type may be performed by the processor 170 of the user terminal 100 and the processor 370 of the server 300.

First, the processor 170 of the user terminal 100 may receive (S1001) an input of a voice message from the user 102. Then, the processor 170 may check setting of a type of a message (S1002) to be transmitted while the vehicle 101 is connected to the NTN.

Meanwhile, the user terminal 100 according to the disclosure may set a text data transmission method as a default mode in consideration of a limited bandwidth in the NTN environment. However, the disclosure is not limited thereto, and a default transmission mode may be operated variably depending on a system policy or a state of available network resources. In an embodiment, a separate setting interface via which a user may explicitly select voice transmission may be provided through an infotainment system of the vehicle 101 or a setting menu of the user terminal 100. The processor 170 determine a user set value or importance of data in operation S1002 and branch a transmission format into voice packet data (S1003) or text data (S1005).

Depending on the message type of the voice message in operation S1002, the processor 170 may generate voice packet data (S1003) similar to a format of data transmitted and received in the TN environment and split and transmit the voice packet data (S1004), or perform STT to generate text data (S1005) and transmit the text data (S1006).

Then, the server 300 may reconstruct a voice message based on the split voice packet data (S1007) or receive the text data (S1009) depending on the format of the received data. Additionally, the emergency response center 410 may check a user message by performing playback of the voice message (S1008) or TTS-based playback (S1010) using a method corresponding to the embodiment of FIG. 8. In particular, when the text data is received in the NTN environment, the server 300 may perform voice interaction in real time on behalf of a driver by directly performing server-based interactive STT/TTS.

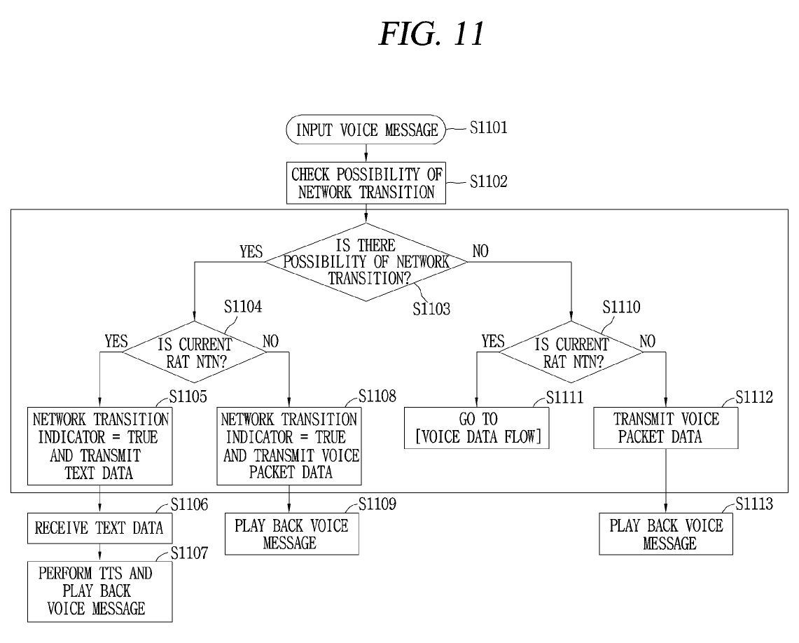

Hereinafter, an embodiment in which voice message transmission and reception based on the network transition prediction according to the disclosure are controlled will be described. In this regard, FIG. 11 illustrates a sequence for dynamically switching a transmission protocol or a data format of a voice message based on a possibility of network transition according to the disclosure.

Referring to FIGS. 1 to 11, an operation of controlling transmission and reception of voice messages based on the network transition prediction according to the disclosure may be performed by the processor 170 of the user terminal 100 and the processor 370 of the server 300.

The processor 170 according to the disclosure may receive (S1101) an input of a voice message from the user 102.

Then, the processor 170 may check a possibility of network transition at a preset interval (S1102). In an embodiment, the processor 170 may analyze current location information of the user terminal 100 or the vehicle 101, a driving speed, and a change in communication quality (a received signal strength indicator (RSSI), etc.) on a driving path at a monitoring interval of about two seconds. Based on this, the processor 170 may check whether a probability of occurrence of a handover between a TN and an NTN within a preset threshold time exceeds a threshold value.

Additionally, the processor 170 according to the disclosure may set and manage the possibility of network transition, obtained as a result of the analyzing, in a form of state variables or control parameters within the user terminal 100 or the vehicle 101. That is, the processor 170 may update and maintain values of the state variables in real time through periodic monitoring, and determine an optimal transmission mode with reference to a corresponding state variable value during determination (S1103) to be performed thereafter.

Then, the processor 170 may determine whether there is a possibility of network transition (S1103). As a result of the determination, when a possibility of network transition is present ('yes' in operation S1103), the processor 170 may predict that a handover between the TN and the NTN is to occur within the threshold time.

Then, the processor 170 may further determine (S1104) whether current RAT is the NTN.

When the current RAT is the NTN ('yes' in operation S1104), the processor 170 may generate text data corresponding to the voice message to suit a current NTN communication environment. In addition, the processor 170 may set a network transition indicator to TRUE, and add the network transition indicator to the text data to transmit the text data to which the network transition indicator is added (S1105) to indicate a state that network transition is scheduled. That is, the user terminal 100 allows the server 300 to recognize in advance a forthcoming transition to the TN through the network transition indicator, while maintaining a transmission method corresponding to currently connected RAT.

In correspondence with this, the server 300 or the emergency response center 410 may perform TTS on received text (S1106) to play back the voice message (S1107). At the same time, the server 300 may check a value of the network transition indicator added to the text data. When the network transition indicator value is set to TRUE, the server 300 may recognize in advance that a communication environment of the vehicle 101 is to switch from the NTN to the TN within the preset threshold time. Accordingly, the server 300 may construct and transmit a response message in a transmission method suitable for a TN communication environment. Thus, the transmission and reception of the voice message with the user may be maintained without interruption even when the network transition from the NTN to the TN occurs.

Meanwhile, as a result of the determination in operation S1104, when the current RAT is the TN rather than NTN, the processor 170 may convert the voice message into voice packet data to suit a current TN environment and transmit the voice packet data to the server 300. In this case, the network transition indicator may be also set to TRUE to indicate that a network transition is scheduled. Additionally, the processor 170 may add the network transition indicator to the voice packet data and transmit the voice packet data to which the network transition indicator is added (S1108).

In correspondence with this, the server 300 may receive the voice packet data, and reconstruct and play back the voice message based on the received voice packet data (S1109). Additionally, when a value of the network transition indicator added to the received voice packet data is set to TRUE, the server 300 may recognize that a communication environment of the vehicle 101 is to change from the TN to the NTN within the threshold time. Accordingly, the server 300 may construct and transmit a response message in a transmission method suitable for the NTN communication environment. Thus, even when a network transition occurs from the TN to the NTN, the transmission and reception of the voice message with the user may be maintained without interruption.

Additionally, as a result of the determination in operation S1103, when a possibility of network transition is not present ('no' in operation S1103), the processor 170 may further check whether current RAT is the NTN (S1110).

When the current RAT is an NTN ('yes' in operation S1110), the processor 170 may perform voice message processing (S1111) by maintaining an existing voice data flow. In this case, since a possibility of network transition is not present, the network transition indicator may be set to FALSE or may not be included.

Accordingly, the server 300 may perform TTS on text data received based on the NTN and play back a corresponding voice message. Although not shown in the drawings, this process may be performed according to a procedure for processing an NTN-based voice message as described above. Additionally, when a value of the network transition indicator is set to FALSE or is not included, the server 300 may determine that there is no possibility of network transition within the threshold time. Accordingly, when transmitting a subsequent response message, the server 300 may employ a transmission method suitable for a current NTN communication environment of the vehicle 101.

Meanwhile, as a result of the determination in operation S1110, when current RAT is the TN rather than the NTN, the processor 170 may convert the voice message into voice packet data suitable for a TN environment and transmit (S1112) the voice packet data to the server 300. Even in this case, the network transition indicator may be set to FALSE or may not be included.

In correspondence with this, the server 300 may receive the voice packet data, and reconstruct and play back the voice message based on the received voice packet data (S1113). Additionally, when the network transition indicator value is set to FALSE or is not included, the server 300 may determine that there is no possibility of network transition within the threshold time. Accordingly, when transmitting a subsequent response message, the server 300 may employ a transmission method suitable for a current TN communication environment of the vehicle 101.

As described above, a seamless voice message transmission method according to the disclosure may dynamically control a transmission format and a processing flow of a voice message by taking into account both whether a network transition indicator is set and a current RAT state. This may ensure that the voice message is seamlessly transmitted and played back, even when a network transition between the TN and the NTN is scheduled.

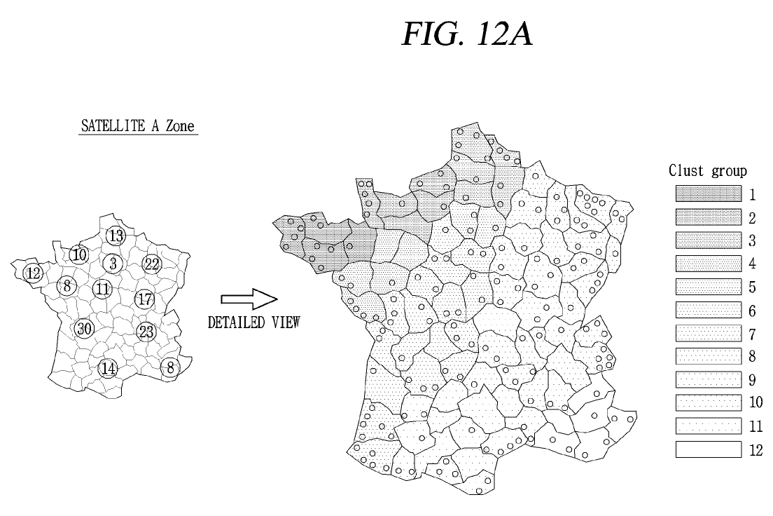

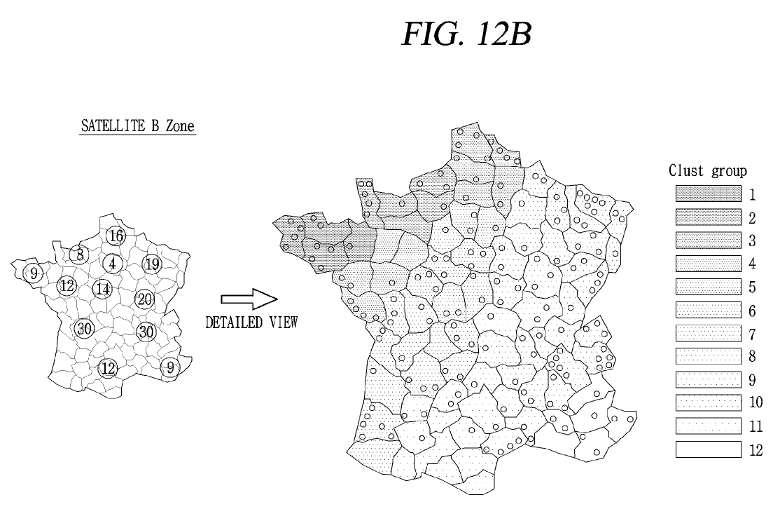

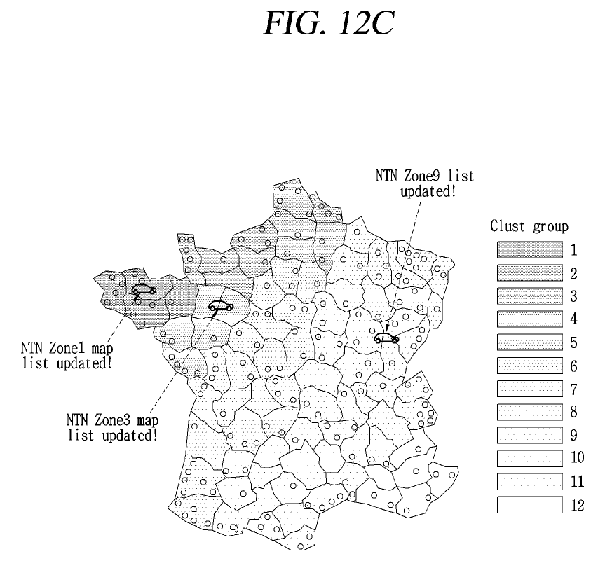

Hereinafter, a method of generating and managing an NTN map according to the disclosure is to be described. In this regard, FIGS. 12A to 12C illustrate examples of a method of generating an NTN map based on vehicle status information and orbit information with respect to each satellite operator according to the disclosure.

Referring to FIGS. 1 to 12C, a process of generating and managing an NTN map may be performed by the server 300 according to the disclosure. As described above with reference to FIG. 5, the server 300 according to the disclosure may collect vehicle status information from a plurality of vehicle terminals including the vehicle 101 at a predetermined interval to generate and manage an NTN map based on a region.

In the specification, the NTN map may include information about an NTN communication available area on a driving path of the user terminal 100. In addition, the NTN map according to the disclosure may be generated in units of zones by clustering communication state data collected from the plurality of vehicle terminals including the user terminal 100. The respective generated zones may be managed separately for each of a plurality of satellite operators.

In this regard, the server 300 may perform a process of preprocessing collected raw data. In an embodiment, the data preprocessing process may be performed in an order of signal filtering, threshold application, and noise removal. Accordingly, noise and error data may be removed to generate reliable map information.

Then, based on such preprocessed data, the server 300 may define, as an NTN zone, a communication zone satisfying all of NTN zone conditions described below.
i) NTN RSRP condition: -130 <= NTN RSRP <= -113 dBm
ii) GPS threshold value condition: |actual travel distance - GPS measurement value| <= preset threshold value
iii) TN S/N noise condition: TN S/N noise <= 0

In this regard, the NTN RSRP represents strength of a reference signal received from the NTN by the vehicle 101, and may be used as a key index for determining quality and availability of an NTN service. Based on received NTN RSRP, the server 300 according to the disclosure may determine whether a signal strength reception state of the non-terrestrial network (NTN) is within an appropriate range in which a stable communication service may be performed.

In an embodiment, a threshold value of the NTN RSRP may be set to have a lower limit of -130dBm and an upper limit of -113 dBm. -130 dBm may be set as a lower limit of a weak signal at which communication begins to become unstable. Accordingly, the server 300 may not classify, as the NTN zone, an area in which signal strength is equal to or below the low limit. In addition, -113 dBm may be set as an upper limit at which a relatively stable connection to the NTN may be performed. This may function to define an NTN-dedicated area in which an NTN service is stably provided without competing with the TN.

A GPS threshold value is a reference related to positioning accuracy of the vehicle 101, and may be defined as a distance deviation between an actual driving trajectory and a GPS measurement trajectory. Since the NTN service has characteristics of location-based communication combined with satellite orbit information, this condition may be used to enhance service stability in environments with high positioning accuracy. In an embodiment, the GPS threshold value may be set to an error range of 3 m to 5 m.

In addition, the TN S/N noise may indicate quality of a terrestrial network signal. "TN S/N noise <= 0" indicate a state in which noise power is equal to or greater than terrestrial network signal power, and may mean that stable communication via the TN may not be performed. This condition separates and defines, as NTN zones, regions in which TN interference or influence is extremely insignificant, and may limit areas such that the NTN functions as an essential service provider in locations in which the TN communication fails.

Then, the server 300 may generate NTN zone groups and match administrative regions based on information of the defined NTN zones. In this regard, referring to FIG. 12A, the server 300 may generate zone groups by grouping previously identified NTN zones based on geographic proximity.

In an embodiment, the server 300 may construct and update a meaningful zone database (DB) with scattered NTN points by performing spatial clustering using density-based spatial clustering of applications with noise (DBSCAN) or a mean shift algorithm. Then, the server 300 may match corresponding zones to actual administrative districts by applying a spatial join and spatial `k'luster analysis by tree edge removal (SKATER) or K-Means localization technique to the generated zone groups. The matching to the administrative districts may enable the user terminal 100 to efficiently index and manage NTN availability information for a region to which the user terminal 100 belongs.

Meanwhile, the server 300 according to the disclosure may independently classify and manage the generated NTN zones according to a visibility range (a footprint) and service policies for each of a plurality of satellite operators.

In this regard, referring to FIGS. 12B and 12C, even with respect to NTN points (indicated by black circles) in a same geographic location, the server 300 may individually manage communication availability information for each satellite network in combination with orbital information of a satellite operator (e.g., a satellite A or a satellite B) in charge of a corresponding area. That is, the server 300 may maintain same physical coordinate data, while individually indexing and managing whether a corresponding point functions as a communicable gateway depending on a connected satellite operator.

For example, as shown in FIG. 12B, information about cluster groups (Clust groups 1 to 12) included within a visible area of a particular satellite operator (the satellite B) may be managed within an integrated database of the server 300. In addition, the managed information may be converted into a map list specialized for a connection environment and a visibility range of each satellite to be distributed to the user terminal 100 of the vehicle 101.

Meanwhile, the vehicle 101 according to the disclosure may perform automatic update of a map of an NTN zone (NTN zone map auto update) on basis of an administrative district in which driving is performed.

In this regard, referring to FIG. 12C, the vehicle 101 may identify a current location of the vehicle 101 in real time and, upon entering a particular administrative district (Clust group) or moving within the corresponding district, receive latest map data from the server 300 to update a local map. For example, when the vehicle 101 enters a 'Clust group 1' region, a trigger such as "NTN Zone1 map list updated!" occurs within a terminal, and an NTN availability list for the corresponding region may be synchronized. Likewise, whenever the vehicle 101 reaches a 'Clust group 3' region or a 'Clust group 9' region along a driving path of the vehicle 101, NTN list information that matches each region may be automatically updated.

Such an active map update process on a vehicle side may be utilized as key foundational data in the checking of a possibility of network transition (S1102) described above with reference to FIG. 11. That is, the vehicle 101 may accurately predict a handover point on a driving path based on an automatically updated latest NTN map to thereby set a seamless mode transition indicator (TRUE/FALSE) between the TN and the NTN.

Meanwhile, although the process of determining an NTN zone and generating/managing a zone map has been described as being performed by the server 300 in the specification, it should be noted that, depending on an embodiment, the process may be performed independently by the user terminal 100 of the vehicle.

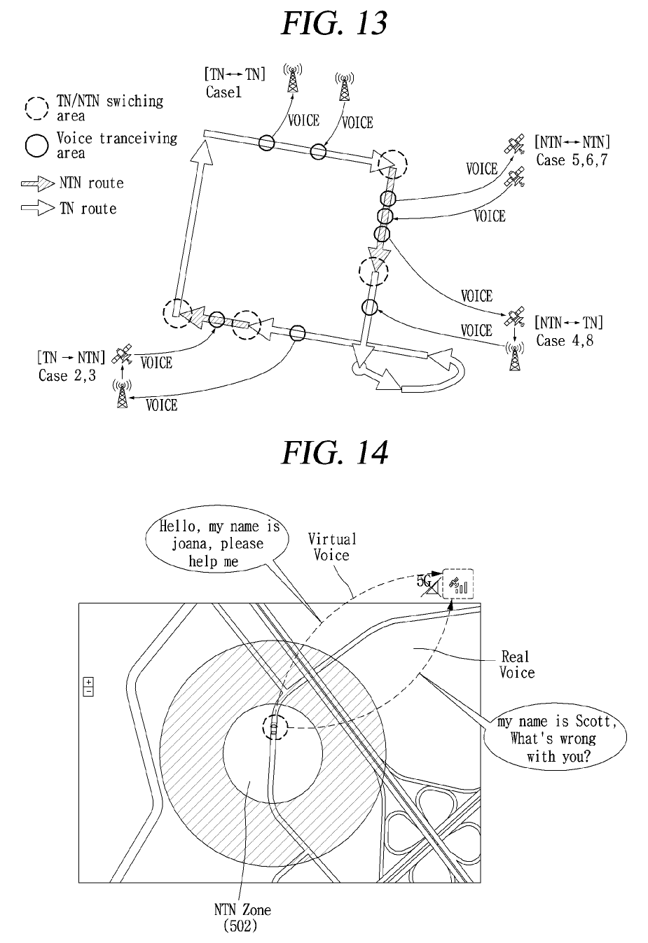

Hereinafter, a method of seamlessly transmitting and receiving voice messages based on a network environment and a terminal state according to the disclosure will be described. In this regard, FIG. 13 is a conceptual diagram of a voice message transmission and reception scenario for determining a transmission protocol and a data format based on a result of predicting of a network transition area (TN/NTN switching area) according to the disclosure.

Referring to FIGS. 1 to 13, a process of seamlessly transmitting and receiving voice messages according to the disclosure may be performed by the processor 170 of the user terminal 100 and the processor 370 of the server 300.

The method of transmitting and receiving voice messages according to the disclosure may be described as being classified at least into cases described below, depending on whether a network transition indicator is set, a type of currently connected RAT, and a data format of the voice message.

Here, the data format of the voice message may include real voice which is an actual voice packet, and virtual voice which is text data–based voice, and each may correspond to available network bandwidth states of the TN and NTN, respectively. In detail, the 'real voice' corresponds to original voice packet data, and the 'virtual voice' may correspond to a variable transmission data format in which text data converted via STT is transmitted and then output back in a voice form at a receiving side.
Case 1: sending TN real voice and receiving TN real voice
Case 2: sending TN real voice and receiving NTN real voice
Case 3: sending TN real voice and receiving NTN virtual voice
Case 4: sending NTN real voice and receiving TN real voice
Case 5: sending NTN real voice and receiving NTN virtual voice
Case 6: sending NTN real voice and receiving NTN real voice
Case 7: sending NTN virtual voice and receiving NTN virtual voice
Case 8: sending NTN virtual voice and receiving TN real voice

First, Case 1, i.e., a scenario in which voice messages are transmitted and received between TNs is described. Referring to a TN route in FIG. 13, Case 1 is a most common service scenario in which the user terminal 100 and the server 300 communicate with each other through the TN.

In an embodiment, the user terminal 100 converts a user voice message into voice packet data and transmits the voice packet data to the server 300 via the TN, and in response to this, the server 300 may generate response voice packet data and transmit the response voice packet data to the user terminal 100 via the TN. In this case, it may be determined that there is no possibility of network transition within a threshold time, and a network transition indicator may be set to FALSE or may not be included.

Then, Case 2 and Case 3, i.e., scenarios in which messages are transmitted via the TN and received via the NTN are described. This may include a case in which the user terminal 100 transmits a voice message through the TN and the server 300 transmits a response message through the NTN. In this case, for seamless voice message transmission and reception, the user terminal 100 may transmit voice packet data through the TN, and set a network transition indicator to TRUE to indicate that a network transition is scheduled to occur within a threshold time.

The server 300 may recognize a possibility of transition from the TN to the NTN in advance by checking the network transition indicator included in received data, and transmit a response message by transitioning to an NTN communication method instead of the TN currently connected. For example, in Case 2, the server 300 may transmit a response message in a form of voice packet data (real voice) through the NTN. On the other hand, in Case 3, the server 300 may transmit a response message using a virtual voice transmission method in which STT and TTS are performed on the voice message, in consideration of a satellite communication bandwidth.

In addition, Cases 5, 6, and 7, i.e., scenarios in which voice messages are transmitted and received within an NTN environment are described. Referring to an NTN route in FIG. 13, Cases 5 to 7 are scenarios in which both the user terminal 100 and the server 300 transmit and receive voice messages in an NTN environment. In this case, since it is determined that there is no possibility of network transition within a threshold time, a network transition indicator may be set to FALSE or may not be included.

In correspondence with this, the server 300 may determine a response method according to a network state. For example, the server 300 may provide a response message using a method of transmitting and receiving voice packet data as is (Case 6), a virtual voice transmission method in which voice messages are converted into text data to be transmitted and received (Case 7), or a method of combining voice packet data with a virtual voice method (Case 5).

Finally, Case 4 and Case 8, i.e., scenarios in which a voice message is transmitted via the NTN and a voice message is received via the TN are described. These are cases when the user terminal 100 transmits a voice message via the NTN and the server 300 responds to this via the TN.

When entering a network transition area (a TN/NTN switching area) indicated by a dashed circle on an NTN route along a dashed path and transmitting data via the NTN, the user terminal 100 may set a network transition indicator to TRUE to indicate that a network transition is scheduled. In addition, the server 300 may identify the network transition indicator in the received data to recognize in advance a possibility of network transition from the NTN to the TN. Accordingly, when transmitting a response message to the user terminal 100, the server 300 may ensure continuity of communication by switching to a TN communication method on a TN route.

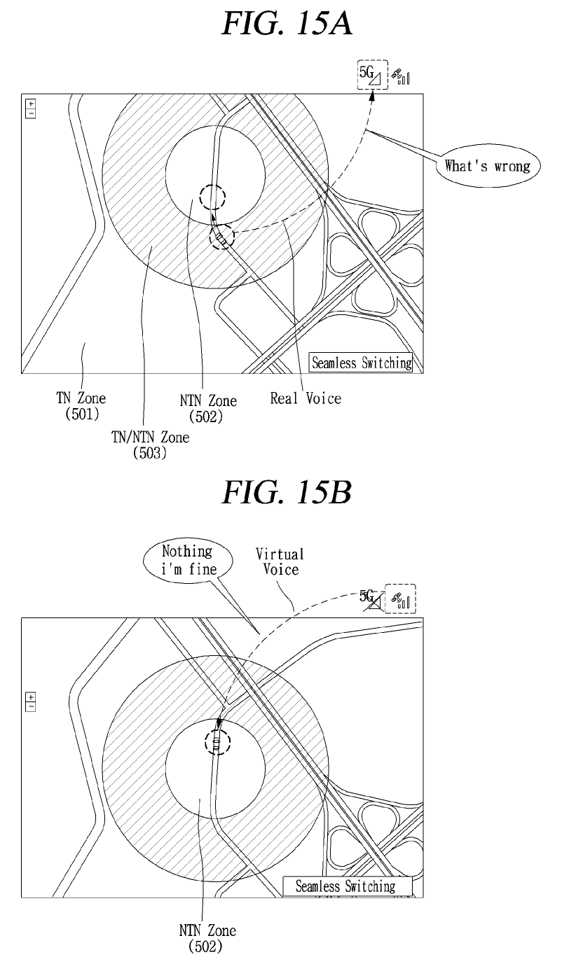

Hereinafter, an embodiment in which voice messages are transmitted and received based on a network state and a location according to the disclosure will be described. In this regard, FIG. 14 illustrates an embodiment in which voice messages are transmitted and received in an NTN environment according to the disclosure. Additionally, FIGS. 15A and 15B illustrate embodiments in which voice messages are transmitted and received when a communication zone is changed from the TN to the NTN according to the disclosure, respectively.

Referring to FIGS. 1 to 15, an operation of controlling transmission and reception of voice messages based on a network state and a location according to the disclosure may be performed by the processor 170 of the user terminal 100 and the processor 370 of the server 300.

First, referring to FIG. 14, a scenario in which the vehicle 101 exchanges voice messages with the server 300 while traveling through the NTN zone 502 that a terrestrial network signal does not reach is presented. At this time, a terrestrial network signal (5G Power) in a location of the vehicle 101 during the traveling is -255 dBm, indicating a state in which communication cannot be performed, whereas a satellite signal (satellite power) is measured at -129 dBm, allowing a service through a non-terrestrial network to be maintained. In this case, an NTN network indicator showing that NTN communication is in an active state may be displayed at an upper right end of the display 180, and may visually indicate an NTN connection state and signal strength.

In such an NTN environment, the vehicle 101 and the server 300 may select an optimal message transmission mode by measuring QoS based on each link quality (latency, a packet loss rate, an SNR, etc.). For example, as illustrated in FIG. 14, the vehicle 101 may determine that the measured QoS is at a level where actual voice transmission may be performed and transmit a message as real voice which is an original voice packet. On the other hand, the server 300 may determine to respond in a form of virtual voice based on measured QoS metrics such as a bandwidth status of a satellite downlink and network congestion.

Meanwhile, when a current location of the user terminal 100 or the vehicle 101 according to the disclosure is in the NTN zone 502, the processor 170 may generate voice data by encoding a voice message at a low bit rate. Additionally, the processor 170 may operate in a hybrid transmission mode in which text data and the voice data generated at the low bit rate are transmitted together.

Additionally, the processor 170 of the user terminal 100 or the processor 370 of the server 300 may receive the text data and the voice data generated at the low bit rate. At this time, the processor 170 or 370 may convert the text data into a voice message and play back the voice message, while blending the voice data generated at the low bit rate as background sound to output the voice data generated at the low bit rate together. This blending process may simultaneously provide clear information delivery based on text and a sense of realism from actual voice.

In addition, to preserve voice features of a sender, a voice identifier may be transmitted as metadata along with the text to be utilized to maintain a TTS tone color. This allows a receiving stage to play back a message with a tone color similar to that of the sender even when outputting virtual voice.

Then, referring to FIGS. 15A and 15B, a change in a communication environment which occurs when the vehicle 101 enters the NTN zone 502 from the TN zone 501 and a seamless voice messaging service scenario corresponding thereto are presented.

First, referring to FIG. 15A, a region in which the vehicle 101 is currently located may be in the TN/NTN zone 503 in which both the TN and the NTN are present. The user terminal 100 or the vehicle 101 according to the disclosure may include two built-in modems supporting a dual subscriber identity module (SIM) dual standby (DSDS) function, and be equipped with a protocol stack capable of simultaneously accommodating heterogeneous communications. Accordingly, the vehicle 101 may perform mutually complementary communication when both networks are active.

The vehicle 101 may select an optimal communication method based on preset priorities such as network service quality (QoS) measured at a time point of message transmission, whether there is an emergency context, or a communication fee policy. In an embodiment, in a case of FIG. 15A, a terrestrial network signal (5G Power: -105 dBm and SINR: 15 dB) and a satellite signal (satellite power: -129 dBm and SINR: 0 dB) may be measured simultaneously. In this case, the vehicle 101 may transmit voice messages through the TN with higher QoS metrics.

In addition, to indicate that both the TN and NTN communications are available, both a TN network indicator and an NTN network indicator may be displayed as being active at an upper right end of the display 180. In addition, the TN network indicator corresponding to a communication path selected to be used to transmit and receive voice messages may be highlighted to be visually distinguished from another network indicator, i.e., the NTN network indicator.

At this time, the processor 170 of the user terminal 100 may predict a change in a communication zone on a driving path based on an NTN map received from the server 300 and determine whether to perform a network transition. In detail, the processor 170 may calculate a predicted transition time point based a driving speed of the vehicle 101, a rate of change of the RSRP of a terrestrial network, and a threshold value of GPS-based location information, and upon entering a set radius (e.g., R1 to R3 in FIG. 6A) for transition preparation, a transition preparation logic for each step may be operated. Additionally, when it is determined that TN communication disconnection is expected within a threshold time and a network transition is to be performed, the processor 170 may set a network transition indicator to TRUE and add the set network transition indicator to data to cause the server 300 to recognize this in advance.

Simultaneously, in response to a time point of an imminent transition, an STT operation of preparing for conversion from real voice to virtual voice may be performed in advance and a voice identifier for ensuring continuity of data transmission may be generated and attached.

Then, referring to FIG. 15B, a state in which the vehicle 101 has traveled to fully enter the NTN zone 502 is shown. At this time, a terrestrial network signal (5G Power) is rapidly weakened to -255 dBm and cut off, whereas a satellite signal is maintained at a stable level (-129 dBm). At this time, since the server 300 has recognized a network transition of the vehicle 101 through a received network transition indicator in advance, the server 300 may transmit a response message through an NTN route instead of a TN route at a time point of transmitting the response message. Accordingly, the vehicle 101 receive a response voice message in an NTN transmission protocol and a data format (e.g., virtual voice) even in an environment in which TN communication is interrupted.

Then, in the NTN zone 502, the vehicle 101 may transmit or receive data of virtual voice based on text with a high priority in a low-bandwidth environment. In addition, when the virtual voice is received, TTS may be performed based on an attached voice identifier to play back a voice message with a tone color similar to that of a sender. Such a logic may be applied to an opposite case such as a scenario of entering the TN from the NTN. As a result, the user 102 is provided with a seamless voice message transmission and reception service in which communication interruption is not perceived.

Meanwhile, a method of controlling transmission of a voice message based on network transition prediction, the method being performed by a user terminal and a server according to another aspect of the disclosure, is not limited thereto and may be variously applied in combination with the embodiments of FIGS. 1 to 15B.

A system configured to seamlessly transmit a voice message based on network transition prediction according to the specification and a method of operating the system have been described above. Technical effects of the voice message transmission system according to the specification and a method of operating the same may be summarized as described below, but are not limited thereto.

According to the disclosure, communication interruption and a handover delay which may occur during network transition may be effectively prevented by proactively predicting network transition between the TN and the NTN based on a driving path of the vehicle 101 and sharing state information with a server. Accordingly, a user may receive a seamless latency-free voice messaging service in spite of rapid changes in a communication environment, and continuity and reliability of the service may be improved.

According to the disclosure, even in a low-bandwidth and high-latency environment of the NTN, communication resource constraints may be efficiently overcome by dynamically selecting real voice and a virtual voice format in correspondence with a network state and performing a hybrid transmission method of combining text and low-bitrate voice with each other. This allows to optimize a data packet size to increase a communication success rate, while enabling rapid and accurate transmission of main information of a message even under network congestion contexts.

According to the disclosure, waste of limited satellite communication resources may be minimized by optimizing a data format prior to a change in a communication zone through intelligent predictive control technology and dynamically controlling a transmission path by enabling a server to recognize a location change of a terminal. In addition, through close interoperation between the server and the terminal, an optimal path for receiving a response message may be secured in any network environment, thereby maximizing operational efficiency of the entire system.

According to the disclosure, individual voice features may be preserved even in text-based communication under low-bandwidth environments by performing speech synthesis and restoration for reproducing a unique voice color of a speaker using a voice identifier transmitted when virtual voice is received. Accordingly, a high-quality voice service for preserving a sense of realism and identity of a sender beyond mere information delivery may be provided, and user experience (UX) and service satisfaction may be enhanced.

The present disclosure may be implemented as computer-readable codes on a medium having a program recorded thereon. The computer-readable medium includes all kinds of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). The computer may include the control unit of the terminal. Therefore, it should also be understood that the above-described embodiments are not limited by any of the details of the foregoing description, unless otherwise specified, but rather should be construed broadly within its scope as defined in the appended claims, The scope of the disclosure should be determined by reasonable interpretation of the appended claims, and all changes within the scope of equivalents of the disclosure are included in the scope of the disclosure.

What is claimed is:

1. A user terminal comprising:
a microphone configured to receive a voice message;
a communication module comprising an antenna and configured to enable terrestrial network (TN) communication and non-terrestrial network (NTN) communication using a satellite; and
a processor operably connected to the communication module and configured to transmit the voice message using at least one communication method from among the TN communication and the NTN communication, wherein the processor is configured to:
predict a communication zone corresponding to an expected location on a driving path of the user terminal, based on a TN signal or an NTN signal each collected through the antenna;
determine a transmission protocol or a data format of the voice message based on a result of the prediction; and
transmit, to a server, the voice message constructed according to the determination.

2. The user terminal of claim 1, wherein the communication zone is classified into a TN zone, an NTN zone, and a TN/NTN zone, and
the TN/NTN zone is a network transition preparation area between the TN communication and the NTN communication.

3. The user terminal of claim 2, wherein the processor variably adjusts a coverage boundary of the TN/NTN zone in proportion to a driving speed of a vehicle in which a user of the user terminal is riding.

4. The user terminal of claim 2, wherein, when a current location of the user terminal is in the NTN zone, the processor controls the voice message to be converted into text data to cause the text data to be transmitted to the server via the satellite.

5. The user terminal of claim 2, wherein, when a current location of the user terminal is in the TN zone, the processor controls the voice message to be transmitted to the server via a terrestrial network base station.

6. The user terminal of claim 1, wherein the processor is configured to:
predict a possibility of a change in the communication zone within a preset threshold time based on at least one from among an NTN map, a vehicle location, and the driving path, each received from the server; and
determine whether a network transition between the TN communication and the NTN communication is to be performed within the preset threshold time, based on a result of the prediction.

7. The user terminal of claim 6, wherein, when it is determined that the network transition between the TN communication and the NTN communication is to be performed within the preset threshold time, the processor adds, to the voice message, a network transition indicator notifying that the network transition is scheduled and transmits the voice message to which the network transition indicator is added.

8. The user terminal of claim 2, wherein, when a current location of the user terminal is in the TN/NTN zone, the processor transmits the voice message by selecting at least one communication method among the TN communication and the NTN communication based on network quality of service (QoS) of the TN communication and the NTN communication.

9. The user terminal of claim 8, wherein the processor displays, on a display of the user terminal, a first network indicator and a second network indicator indicating connection states and signal strengths of the TN communication and the NTN communication, respectively, and
the first network indicator corresponds to the selected communication method and is visually distinguished from the second network indicator.

10. The user terminal of claim 1, wherein the processor is configured to:
analyze the voice message to determine whether an emergency context has occurred or an emergency urgency level; and
according to a result of the determination, transmit the voice message by selecting at least one communication method among the TN communication and the NTN communication.

11. The user terminal of claim 10, wherein the processor is configured to:
transmit a text message corresponding to the voice message via the NTN communication when the emergency urgency level is equal to or greater than a preset threshold value; and
control the transmission of the voice message via the NTN communication to be delayed when the emergency urgency level is less than the preset threshold value.

12. The user terminal of claim 4, wherein the processor is configured to:
in the converting of the voice message into the text data, obtain a voice identifier for identifying personal voice features of a user from the voice message; and
add the voice identifier to the text data, and transmit the text data to which the voice identifier is added.

13. The user terminal of claim 12, wherein, when the text data is received, the processor converts the text data into a voice message and plays back the voice message obtained by the converting, based on the voice identifier added to the text data, and
the personal voice features corresponding to the voice identifier are reflected in the voice message obtained by the converting.

14. The user terminal of claim 4, wherein the processor performs at least one of summarization and compression on the text data, and transmits the text data on which the at least one of summarization and compression is performed.

15. The user terminal of claim 4, wherein the processor is configured to:
generate voice data by encoding the voice message at a low bit rate when a current location of the user terminal is in the NTN zone; and
transmit the text data together with the voice data generated at the low bit rate.

16. The user terminal of claim 15, wherein, when the text data and the voice data at the low bit rate are received, the processor converts the text data into a voice message and plays back the voice message obtained by the converting, and blends the voice data generated at the low bit rate as background sound and outputs the background sound together.

17. The user terminal of claim 6, wherein the NTN map comprises information about an NTN communication available area on the driving path of the user terminal.

18. The user terminal of claim 17, wherein the NTN map is generated in units of zones by clustering communication state data collected from a plurality of vehicle terminals comprising the user terminal, and
each of the generated zones is managed separately by each of a plurality of satellite operators.

19. A method of controlling a user terminal, the method comprising:
receiving a voice message through a microphone;
predicting a communication zone corresponding to an expected location on a driving path of the user terminal, based on a terrestrial network (TN) signal or a non-terrestrial network (NTN) signal each collected through the antenna;
determining a transmission protocol or a data format of the voice message based on a result of the prediction; and
transmitting, to a server, the voice message constructed according to the determination using at least one communication method among TN communication and NTN communication according to the determination.

20. A message processing system configured to dynamically transition a method of transmitting a voice message between terrestrial network (TN) communication and non-terrestrial network (NTN) communication, the message processing system comprising:
a user terminal; and a server configured to transmit and receive the voice message to/from the user terminal,
wherein the user terminal comprises:
a microphone configured to receive the voice message;
a communication module comprising an antenna and configured to enable the TN communication and the NTN communication using a satellite; and
a processor operably connected to the communication module and configured to transmit the voice message using at least one communication method from among the TN communication and the NTN communication, wherein the processor is configured to:
predict a communication zone corresponding to an expected location on a driving path of the user terminal, based on a TN signal or an NTN signal each collected through the antenna;
determine a transmission protocol or a data format of the voice message based on a result of the prediction; and
transmit, to the server, the voice message constructed according to the determination.
